(19) United States
(12) Patent Application Publication
(10) Pub. No.: US 2024/0394579 A1
(43) Pub. Date: Nov. 28, 2024

(54) Quantum-Based Analysis of Spin Behavior of Magnetically Equivalent Nuclei

(71) Applicants: International Business Machines Corporation, Armonk, NY (US); University of Notre Dame, Notre Dame, IN (US)

(72) Inventors: Emine Meltem TOLUNAY, Stanford, CA (US); Barbara Anne JONES, Los Gatos, CA (US); Ieva LIEPUONIUTE, San Jose, CA (US); Mariya VYUSHKOVA, Sunnyvale, CA (US)

(21) Appl. No.: 18/321,436

(22) Filed: May 22, 2023

(51) Int. Cl. G06N 10/20; G06N 10/40; G06N 10/60

(52) U.S. Cl. CPC G06N 10/20; G06N 10/40; G06N 10/60

(57) ABSTRACT

One or more systems, devices, computer program products and/or computer-implemented methods provided herein relate to determination of spin behavior of magnetically equivalent nuclei. An example system comprises a memory that stores computer executable components; and a processor that executes the computer executable components stored in the memory. The computer executable components comprise a quantum circuit generation component that generates a quantum circuit defining an atomic system comprising a radical atomic pair that have isotropic hyperfine couplings to three or more groups of magnetically equivalent nuclei; and a quantum operation component that operates the quantum circuit on a set of qubits of a quantum device, wherein excited states of one or more of the qubits of the set of qubits simulate the atomic system.

### TECHNICAL FIELD

The present disclosure relates to determination of spin behavior of magnetically equivalent nuclei, and more specifically to simulation of spin behavior of radical pair systems with an arbitrary number of hyperfine coupling constants using a quantum system.

### BACKGROUND

The dynamics of radical pair systems undergoing quantum beats phenomena can be described by a unitary time evolution defined by hyperfine couplings and unequal Larmor precession rates under an external magnetic field. In general, quantum beats phenomenon can be described as oscillatory behavior of recombination fluorescence intensity of radical pair systems undergoing state conversion by way of intersystem crossing.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments described herein, systems, computer-implemented methods, apparatuses and/or computer program products can provide a process to allow for efficient and partitionable simulation of spin behavior of magnetic nuclei (e.g., magnetically equivalent nuclei of a radical atomic pair of a cation and an anion).

In accordance with an embodiment, an example system comprises a memory that stores computer executable components; and a processor that executes the computer executable components stored in the memory, wherein the computer executable components comprise a quantum circuit generation component that generates a quantum circuit defining an atomic system comprising a radical atomic pair that have isotropic hyperfine couplings to three or more groups of magnetically equivalent nuclei; and a quantum operation component that operates the quantum circuit on a set of qubits of a quantum device, wherein excited states of one or more of the qubits of the set of qubits simulate the atomic system.

In accordance with another embodiment, a computer-implemented method comprises generating, by a system operatively coupled to at least one processor, a quantum circuit defining an atomic system comprising a radical atomic pair that have isotropic hyperfine couplings to three or more groups of magnetically equivalent nuclei and based on a set of parameters comprising an external magnetic field strength that acts on the atomic system; and operating, by the system, the quantum circuit on a set of qubits of a quantum device, wherein excited states of one or more of the qubits of the set of qubits simulate the atomic system.

In accordance with yet another embodiment, a computer program product facilitating a process for determination of spin behavior of magnetically equivalent nuclei comprises a computer readable storage medium having program instructions embodied therewith, the program instructions executable by a processor to cause the processor to generate, by the processor, a quantum circuit defining an atomic system comprising a radical atomic pair that have isotropic hyperfine couplings to three or more groups of magnetically equivalent nuclei; and operate, by the processor, the quantum circuit on a set of qubits of a quantum device, wherein excited states of one or more of the qubits of the set of qubits simulate the atomic system.

In accordance with yet another embodiment, an example system comprises a memory that stores computer executable components; and a processor that executes the computer executable components stored in the memory, wherein the computer executable components comprise a quantum circuit generation component that, instructs execution of a quantum gate of a quantum circuit by generating a quantum circuit based on a plurality of groups of magnetically equivalent nuclei of an atomic system, an exact parameterization of hyperfine coupling constants of the atomic system, and an exact parameterization of a pair of Landé g-factors of the atomic system, wherein the exact parameterizations are expressed by a finite number of digits; a quantum operation component that operates the quantum circuit on a set of qubits; and an analysis component that, based on a measurement readout of a plurality of states of the set of qubits, generates a set of results defining a Hamiltonian time evolution of the radical atomic pairs.

In accordance with yet another embodiment, an example hybrid classical-quantum system, comprises a classical system comprising a memory that stores computer executable components, and a processor that executes the computer executable components stored in the memory, wherein the computer executable components comprise a quantum circuit generation component that, instructs execution of a set of quantum gates of a quantum circuit by generating the quantum circuit based on a plurality of groups of magnetically equivalent nuclei of an atomic system, wherein the atomic system comprises a plurality of radical atomic pairs having isotropic hyperfine couplings to three or more groups of magnetically equivalent nuclei of the plurality of groups of magnetically equivalent nuclei of the atomic system; and a quantum system comprising a quantum processor comprising a set of qubits, and a quantum operation component that operates the quantum circuit on the set of qubits.

An advantage of any one or more of the above-indicated embodiments can be an ability to determine, by simulation, spin behavior of a set of radical pairs (e.g., pairs of identical molecules) with isotropic hyperfine couplings to 3 or more groups of magnetically equivalent nuclei of an atomic system comprising the set of radical pairs. As compared to existing approaches only allowing for such simulation relative to a set of radical pairs with isotropic hyperfine couplings to at most two groups of magnetically equivalent nuclei. That is, for systems having three or more sets of hyperfine coupling constants, classical approaches fail to provide an analytic solution.

Another advantage of the above-indicated embodiments can be use of an exact parameterization, in place of approximations used in existing approached, for a magnetic field strength affecting the sets of radical pairs, for the set of hyperfine coupling constants and/or for a pair of Landé g-factors of the atomic system.

As used herein, an exact or non-approximated number is defined herein as a number without uncertainty that can be expressed exactly by a finite number of digits. Put another way, an exact number is a number which is a true value, while an approximate number is an approximation of a true value. That is, the approximate number is close to but not exactly equal to a number being a true value. Likewise, an exact parameterization as used herein is a parameterization that can be expressed by an exact number, e.g., by a finite number of digits.

In one or more embodiments of the above-indicated systems, computer-implemented method and/or computer program product, a partitioning component reduces the number of qubits comprised by the set of qubits to be employed by generating a plurality of partitions each comprising respective Hamiltonian states with their corresponding degeneracies, wherein each shot a set of shots executed at the quantum device to operate the quantum circuit comprises less than all Hamiltonian states of the quantum circuit.

An advantage thereof can be alignment of the quantum circuit relative to a mapping of the qubits of a quantum device on which the quantum circuit is to be operated. That is, where operating the full quantum circuit in a single shot may employ x qubits, partitioning of the quantum circuit into respective partitions can allow for <x qubits to be employed to operate each of a plurality of shots, where each shot of the plurality of shots comprises one or more partitions resulting from the partitioning of the quantum circuit.

### DESCRIPTION OF THE DRAWINGS

FIG. 1 illustrates a block diagram of an example, non-limiting quantum system that can operate on one or more qubits of the quantum system, in accordance with one or more embodiments described herein.

FIG. 2 illustrates a block diagram of another example, non-limiting system, comprising the quantum system of FIG. 1 and a spin behavior analysis system, in accordance with one or more embodiments described herein.

FIG. 3 illustrates a block diagram of another example, non-limiting system, comprising the quantum system of FIG. 1 and a spin behavior analysis system, in accordance with one or more embodiments described herein.

FIG. 4 provides a first table illustrating spin addition used to count total-spin states and a second table illustrating spin states and associated diagonal terms, in accordance with one or more embodiments described herein.

FIG. 5 provides a chart further illustrating the spin addition referenced at FIG. 4, in accordance with one or more embodiments described herein.

FIG. 6 provides an ordered list of Hamiltonian basis states, in accordance with one or more embodiments described herein.

FIG. 7 provides a schematic illustration of a mixed state simulation quantum circuit, in accordance with one or more embodiments described herein.

FIG. 8 provides a table illustrating trade-offs of varying partitioning strategies that can be employed by a partitioning component of the spin behavior analysis system of FIG. 3, in accordance with one or more embodiments described herein.

FIG. 9 illustrates a process flow for a first procedure for setting up a unitary U_{Ik}, in accordance with one or more embodiments described herein.

FIG. 10 illustrates a first portion of a process flow for a second procedure for setting up a diagonal matrix Λ_{Ik} corresponding to the unitary U_{Ik}, in accordance with one or more embodiments described herein.

FIG. 11 illustrates a second portion of the process flow of FIG. 10 for the second procedure for setting up the diagonal matrix Λ_{Ik} corresponding to the unitary U_{Ik}, in accordance with one or more embodiments described herein.

FIG. 12 illustrates a first partition and a second partition of an example partitioning that can be employed by the partitioning component of the spin behavior analysis system of FIG. 3, in accordance with one or more embodiments described herein.

FIG. 13 illustrates a third partition and a fourth partition of an example partitioning that can be employed by the partitioning component of the spin behavior analysis system of FIG. 3, in accordance with one or more embodiments described herein.

FIG. 14 provides a schematic illustration of another mixed state simulation quantum circuit, but based on equal Landé g-factors, in accordance with one or more embodiments described herein.

FIG. 15 illustrates a table of classical-based post-processing parameters for the partitions illustrated at FIGS. 12 and 13, in accordance with one or more embodiments described herein.

FIG. 16 illustrates a process flow for determining spin behavior of a set of radical pairs with isotropic hyperfine couplings to groups of magnetically equivalent nuclei of an atomic system in accordance with one or more embodiments described herein.

FIG. 17 illustrates a continuation of the process flow of FIG. 6 for determining spin behavior of a set of radical pairs with isotropic hyperfine couplings to groups of magnetically equivalent nuclei of an atomic system in accordance with one or more embodiments described herein.

FIG. 18 illustrates another process flow for determining spin behavior of a set of radical pairs with isotropic hyperfine couplings to groups of magnetically equivalent nuclei of an atomic system in accordance with one or more embodiments described herein.

FIG. 19 illustrates still another process flow for determining spin behavior of a set of radical pairs with isotropic hyperfine couplings to groups of magnetically equivalent nuclei of an atomic system in accordance with one or more embodiments described herein.

FIG. 20 illustrates a block diagram of example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Discussion turns now generally to Hamiltonian simulation of spin behavior in radical pair systems with arbitrary groups (e.g., any number) of magnetically equivalent nuclei. This discussion is relevant to quantum beats phenomena but is not limited thereto.

As used herein, the term “radical pair” refers to a pair of identical molecules.

Generally, singlet state probability evolution of radical pair systems undergoing the quantum beats phenomenon has an analytic solution only for systems with at most two groups of magnetically equivalent nuclei, in existing frameworks.

As an example, the dynamics of radical pair systems undergoing quantum beats phenomena can be described by a unitary time evolution defined by hyperfine couplings and unequal Larmor precession rates under an external magnetic field. In general, the quantum beats phenomenon can be described as the oscillatory behavior of the recombination fluorescence intensity of the radical pair systems undergoing singlet-to-triplet conversions. At any given time, the measured fluorescence intensity can be related to the probability of collapsing the wave function into the singlet state. Radical pairs with isotropic hyperfine couplings to up to 2 groups of magnetically equivalent nuclei is the most complex system for which a generic analytic solution of existing frameworks for spin dynamics is available, absent loss of accuracy and precision due to use of approximations for parameterization.

Accordingly, to account for this deficiency, and/or one or more other deficiencies of existing spin behavior analysis frameworks, one or more embodiments described herein are directed to a hybrid system comprising a classical system and a quantum system that can be employed to determine spin behavior of an atomic system, and more particularly of radical cation/anion atomic pairs that have hyperfine couplings to any arbitrary number of groups of magnetically equivalent nuclei of the atomic system. One or more processes can be operated at the classical system to generate parameters, generate a quantum circuit based on the parameters, partition the quantum circuit, aggregate results obtained from the quantum system due to the partitioning of the quantum circuit, and/or analyze the results to determine the resulting spin behavior sought, and to determine any secondary results extending therefrom. One or more process can be operated at the quantum system to operate the quantum circuit on one or more qubits of the quantum system and/or to output one or more measurement results, such as of states of the one or more qubits operated upon.

The use of the quantum system, and thus the generation of a quantum circuit that is operatable thereon, can allow for analysis of atomic systems having up to two sets of hyperfine coupling constants, but also, more particularly, with atomic systems having three or more sets of hyperfine coupling constants. That is, where existing frameworks employ crude semi-classical approximations for parameterization of related formula (e.g., for approximating the hyperfine coupling constants), the one or more embodiments described herein can provide for determination of and use of exact parameterization of such hyperfine coupling constants and/or for external magnetic field strength applied to the atomic system and/or Landé g-factors of a cation/anion pair of the atomic system.

Furthermore, the one or more embodiments described herein can account for the direct correspondence of (a) the number of qubits needed to operate the quantum circuit and (b) the number of sets of hyperfine coupling constants (e.g., the number of groups of magnetically equivalent nuclei to which the sets of hyperfine coupling constants relate). That is, as the number of sets of hyperfine coupling constants increases, so does the number of qubits needed to operate the corresponding quantum circuit based on the sets of hyperfine coupling constants. Accordingly, the one or more embodiments described herein can provide partitioning of the Hamiltonian states defining the quantum circuit, and thus partitioning of the quantum circuit, to allow for operation of two or more shots at the quantum system to complete operation of the total quantum circuit at the quantum system.

It is noted that the embodiments described herein can have utility in the field of quantum beats phenomena and/or in any other field where it is useful to understand the spin behavior of radical atomic pairs of an atomic system. For example, the one or more embodiments described herein can be extended to nuclei with spins other than ½ and to systems where the radical anion also has hyperfine couplings. Description and discussion herein, while set forth relative to example quantum beats phenomena cases, are therefore not limited to use for analysis relative to quantum beats phenomena only.

Put another way, the one or more embodiments described herein can simulate the coherent Hamiltonian evolution of radical pair systems with an arbitrary number of hyperfine coupling constants, i.e., an arbitrary number of magnetically equivalent spin-1/2 nuclei. To provide this simulation, the one or more embodiments described herein can employ a systematic approach to simulate the Hamiltonian evolution of radical pair systems involving radical cations with an arbitrary number of hyperfine couplings on a quantum computer. The one or more embodiments can construct the Hamiltonian matrix for radical cations characterized by complex hyperfine coupling interactions with multiple groups of magnetically equivalent spin-1/2 nuclei. This approach can take as input the exact values of the hyperfine coupling constants, the external magnetic field strengths, and/or the g-factors of the radical cation and the anion, and therefore does not rely on crude approximations as in existing frameworks.

It is noted that the hyperfine coupling interactions can have exchange coupling, can be interactions without exchange coupling, can have a dipole coupling, can be interactions without a dipole coupling, can have a time-dependent magnetic field, and/or can be interactions without a time-dependent magnetic field.

Discussion now turns herein to one or more example embodiments described in particular relative to use with a quantum device for operation of a quantum circuit. As used herein, a quantum circuit can be and/or can comprise a set of operations, such as for executing one or more gates, performed on a set of real-world physical qubits with the purpose of obtaining one or more qubit measurements. A quantum processor can comprise the one or more real-world physical qubits.

Qubit states only can exist (or can only be coherent) for a limited amount of time. Thus, an objective of operation of a quantum logic circuit (e.g., including one or more qubits) can be to maximize the utilization of the coherence time of the employed qubits. Time spent to operate the quantum logic circuit can undesirably reduce the available time of operation on one or more qubits. This can be due to the available coherence time of the one or more qubits prior to decoherence of the one or more qubits. For example, a qubit state can be lost in less than 100 to 200 microseconds in one or more cases.

Operation of the quantum circuit can be supported, such as by a pulse component (also herein referred to as a waveform generator), to produce one or more physical pulses and/or other waveforms, signals and/or frequencies to alter one or more states of one or more of the physical qubits. The altered states can be measured, thus allowing for one or more computations to be performed regarding the qubits and/or the respective altered states.

Operations on qubits generally can introduce some error, such as some level of decoherence and/or some level of quantum noise, further affecting qubit availability. Quantum noise can refer to noise attributable to the discrete and/or probabilistic natures of quantum interactions.

One or more embodiments are now described with reference to the drawings, where like referenced numerals are used to refer to like elements throughout. As used herein, the terms “entity”, “requesting entity” and “user entity” can refer to a machine, device, component, hardware, software, smart device and/or human.

In the following description, for purposes of explanation, numerous specific details are set forth in order to provide a more thorough understanding of the one or more embodiments. It is evident, however, in various cases, that the one or more embodiments can be practiced without these specific details.

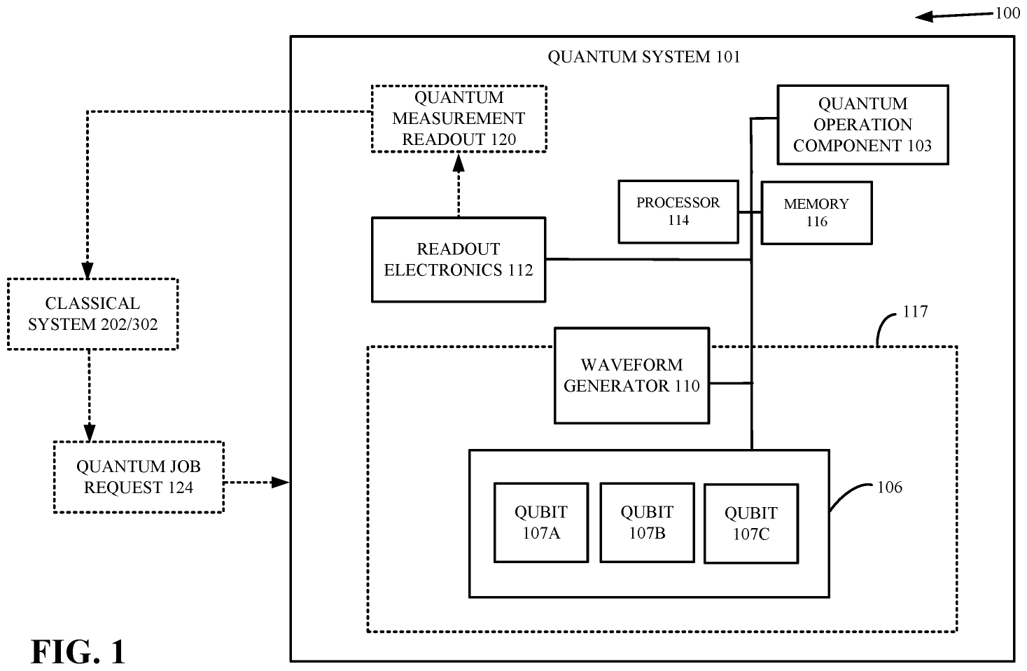

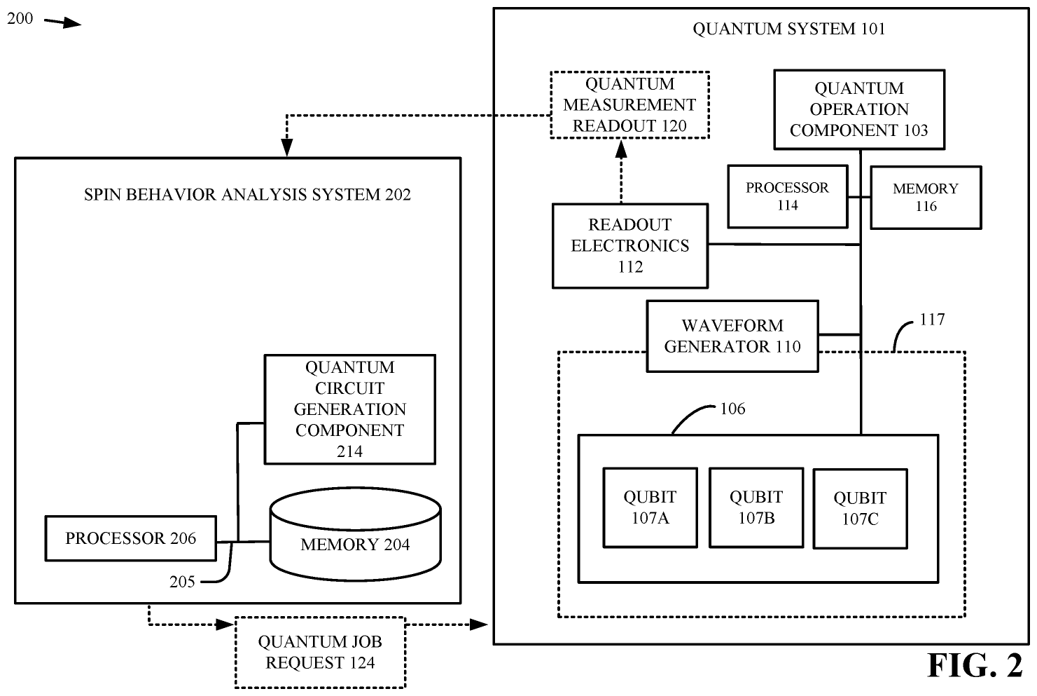

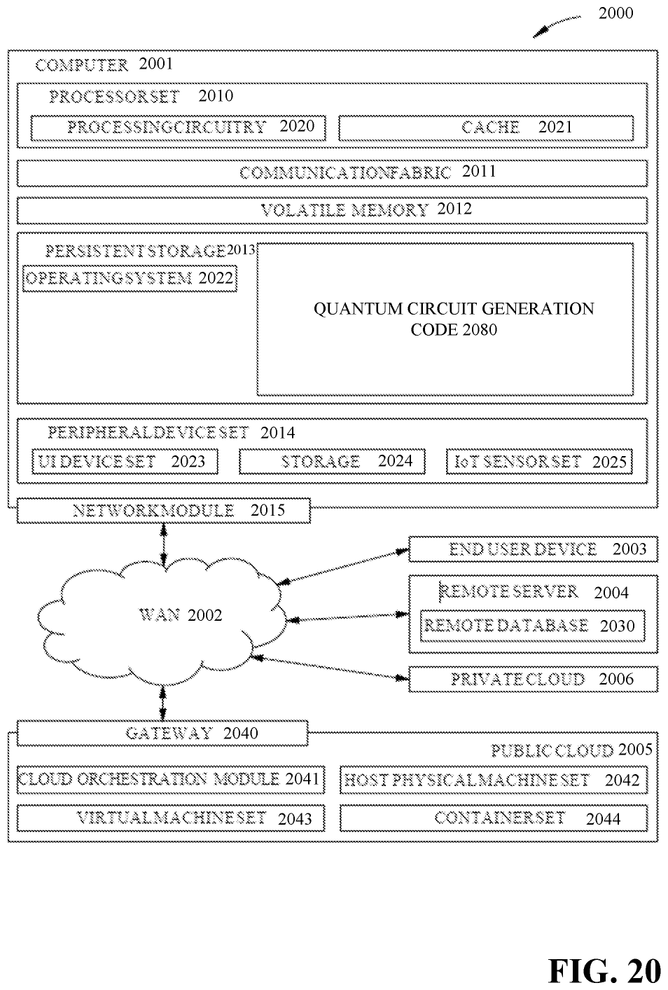

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting systems 100, 200 and/or 300 as illustrated at FIGS. 1, 2 and 3, and/or systems thereof, can further comprise, be associated with and/or be coupled to one or more computer and/or computing-based elements described herein with reference to an operating environment, such as the computing environment 2000 illustrated at FIG. 20. In one or more described embodiments, computer and/or computing-based elements can be used in connection with implementing one or more of the systems, devices, components and/or computer-implemented operations shown and/or described in connection with FIGS. 1, 2 and/or 3 and/or with other figures described herein.

Turning first generally to FIG. 1, one or more embodiments described herein can include one or more devices, systems and/or apparatuses that can provide a process to generate a quantum circuit for a quantum-based operation (e.g., using a quantum device), such as for operating one or more qubits of a quantum device. Accordingly, at FIG. 1, illustrated is a block diagram of an example, non-limiting system 100 that can at least partially facilitate such a process. While referring here to one or more processes, facilitations and/or uses of the non-limiting system 100, description provided herein, both above and below, also can be relevant to one or more other non-limiting systems described herein, such as the non-limiting systems 200 and/or 300, to be described below in detail.

As illustrated at FIG. 1, the non-limiting system 100 can comprise a quantum system 101. Generally, the quantum system 101 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 120, can be responsive to the quantum job request 124 and associated input data and can be based at least in part on the input data, quantum functions and/or quantum computations.

In one or more embodiments, the quantum system 101 can comprise components, such as a quantum operation component 103, a quantum processor 106, pulse component 110 (e.g., a waveform generator) and/or a readout electronics 112. In other embodiments, the readout electronics 112 can be comprised at least partially by a classical system 202 (FIG. 2) and/or be external to the quantum system 101. The quantum processor 106 can comprise one or more, such as plural, qubits 107. Individual qubits 107A, 107B and 107C, for example, can be fixed frequency and/or single junction qubits, such as transmon qubits.

The quantum processor 106 can be any suitable processor. The quantum processor 106 can generate one or more instructions for controlling the one or more processes of the quantum operation component 103.

The quantum operation component 103 can obtain (e.g., download, receive, search for and/or the like) a quantum job request 124 requesting execution of one or more quantum programs and/or a physical qubit layout. The quantum job request 124 can be provided in any suitable format, such as a text format, binary format and/or another suitable format. In one or more embodiments, the quantum job request 124 can be obtained by a component other than of the quantum system 101, such as a by a component of the classical system 102.

In one or more embodiments, a memory 116 and/or processor 114 can be associated with the quantum operation component 103, where suitable.

The quantum operation component 103 can determine mapping one or more quantum logic circuits for executing a quantum program. In one or more embodiments, the quantum operation component 103 and/or quantum processor 106 can direct the waveform generator 110 to generate one or more pulses, tones, waveforms and/or the like to affect one or more qubits 107, such as in response to a quantum job request 124.

The waveform generator 110 can generally perform one or more quantum processes, calculations and/or measurements for shifting the frequency of one or more qubits 107, such as when in respective excited states. For example, the waveform generator 110 can operate one or more qubit effectors, such as qubit oscillators, harmonic oscillators, pulse generators and/or the like to cause one or more pulses to stimulate and/or manipulate the state(s) of the one or more qubits 107 comprised by the quantum system 101.

The quantum processor 106 and a portion or all of the waveform generator 110 can be contained in a cryogenic environment, such as generated by a cryogenic environment 117, such as in a cryostat and/or provided by a dilution refrigerator. Indeed, a signal can be generated by the waveform generator 110 to affect one or more of the plurality of qubits 107. Where the plurality of qubits 107 are superconducting qubits, cryogenic temperatures, such as about 4K or lower can be employed for function of these physical qubits. Accordingly, one or more elements of the readout electronics 112 also can be constructed to perform at such cryogenic temperatures.

The readout electronics 112, or at least a portion thereof, can be contained in the cryogenic environment 117, such as for reading a state, frequency and/or other characteristic of qubit, excited, decaying or otherwise.

Further, the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

Turning next to FIG. 2, but also still referring to FIG. 1, the non-limiting system 200 can be a hybrid system and thus can include both a quantum system and a classical system, such as the quantum system 101 and the classical-based system 202 (also herein referred to as a classical system 202). In one or more other embodiments, the quantum system 101 can be separate from, but function in combination with, the classical system 202. In one or more embodiments, one or more components of the quantum system 101, such as the readout electronics 112, can be at least partially comprised by the classical system 202, or otherwise comprised external to the quantum system 101. In one or more embodiments, one or more components of the classical system 202 can be at least partially comprised by the quantum system 101, or otherwise comprised external to the classical system 202.

The non-limiting system 200 can comprise a spin behavior analysis system 202, being the classical system 202, which can be associated with a cloud computing environment. The spin behavior analysis system 202 can comprise one or more components, such as a memory 204, processor 206, bus 205 and/or quantum circuit generation component 214.

Generally, spin behavior analysis system 202, and thus non-limiting system 200, can facilitate determination of spin behavior of an atomic system via generation of a quantum circuit based on the atomic system, execution of the quantum circuit at the quantum system 101, and analysis of results at the spin behavior analysis system 202, which results are output by and/or made available by the quantum system 101. Spin behavior can be determined for an atomic system comprising any arbitrary number of magnetically equivalent nuclei of the atomic system.

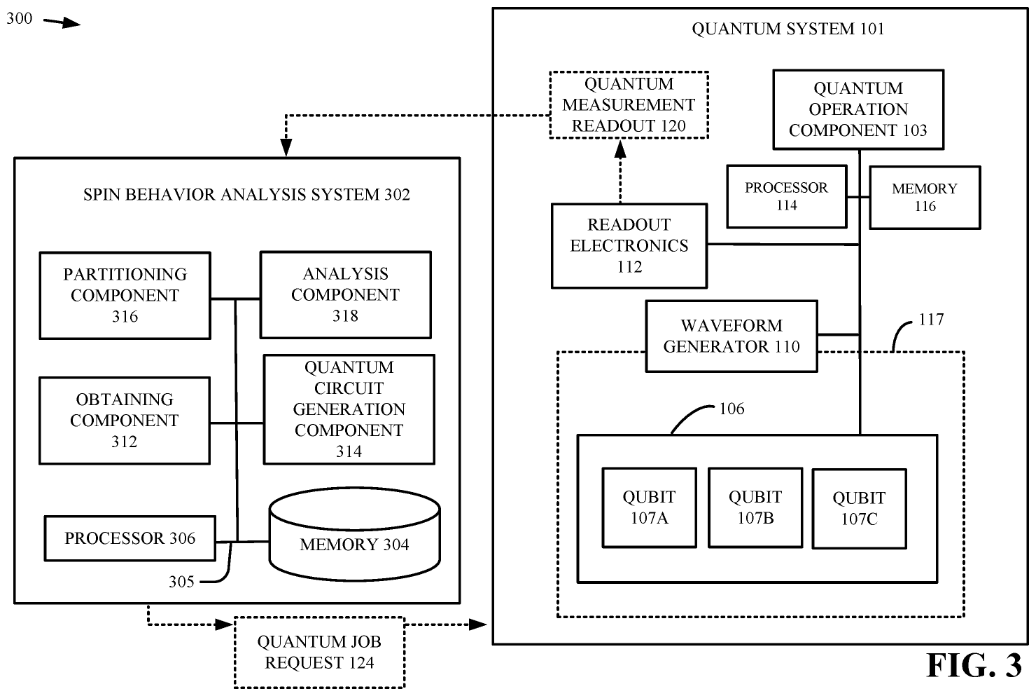

It is noted that non-limiting system 200 is but generally explained to provide a base explanation for further, and more detailed, description below relative to at least the non-limiting system 300 of FIG. 3.

Generally, the quantum circuit generation component 214 can generate a quantum circuit defining an atomic system comprising a radical atomic pair that have isotropic hyperfine couplings to three or more groups of magnetically equivalent nuclei and based on a set of parameters comprising an external magnetic field strength that acts on the atomic system. To simulate the atomic system, and thus obtain results that can be employed to determine spin behavior of the atomic system, the quantum operation component 103 can obtain the quantum circuit, such as via a quantum job request 124 and can direct operation of the quantum circuit on the qubits of the quantum processor 106. The excited states of one or more of the qubits of the set of qubits of the quantum processor 106 can simulate the atomic system.

Turning next to FIG. 3, but also still referring to FIG. 1, the non-limiting system 300 can be a hybrid system and thus can include both a quantum system and a classical system, such as the quantum system 101 and the classical-based system 302 (also herein referred to as a classical system 302). In one or more other embodiments, the quantum system 101 can be separate from, but function in combination with, the classical system 302. In one or more embodiments, one or more components of the quantum system 101, such as the readout electronics 112, can be at least partially comprised by the classical system 302, or otherwise comprised external to the quantum system 101. In one or more embodiments, one or more components of the classical system 302 can be at least partially comprised by the quantum system 101, or otherwise comprised external to the classical system 302.

One or more communications between one or more components of the non-limiting system 300 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol and/or other proprietary and/or non-proprietary communication protocols.

The classical system 302 and/or the quantum system 101 can be associated with, such as accessible via, a cloud computing environment such that aspects of classical processing can be distributed between the classical system 302 and the cloud computing environment.

Next, discussion turns to operations of the classical system 302 that can be performed to facilitate generation of a quantum circuit based on a particular atomic system for use in execution of the quantum circuit by the quantum system 101 to simulate the atomic system.

Generally, the classical system 302 can comprise any suitable type of component, machine, device, facility, apparatus and/or instrument that comprises a processor and/or can be capable of effective and/or operative communication with a wired and/or wireless network. All such embodiments are envisioned. For example, the classical system 302 can comprise a server device, computing device, general-purpose computer, special-purpose computer, quantum computing device (e.g., a quantum computer), tablet computing device, handheld device, server class computing machine and/or database, laptop computer, notebook computer, desktop computer, cell phone, smart phone, consumer appliance and/or instrumentation, industrial and/or commercial device, digital assistant, multimedia Internet enabled phone, multimedia players and/or another type of device and/or computing device. Likewise, the classical system 302 can be disposed and/or run at any suitable device, such as, but not limited to a server device, computing device, general-purpose computer, special-purpose computer, quantum computing device (e.g., a quantum computer), tablet computing device, handheld device, server class computing machine and/or database, laptop computer, notebook computer, desktop computer, cell phone, smart phone, consumer appliance and/or instrumentation, industrial and/or commercial device, digital assistant, multimedia Internet enabled phone, multimedia players and/or another type of device and/or computing device.

The classical system, e.g., a spin behavior analysis system 302, can comprise one or more components, such as a memory 304, processor 306, bus 305, obtaining component 312, quantum circuit generation component 314, partitioning component 316 and/or analysis component 318. Generally, the spin behavior analysis system 302 can perform one or more operations to facilitate generation of a quantum circuit based on an atomic system and simulation of the atomic circuit based on execution of the quantum circuit. It is noted that use of the spin behavior analysis system 302 can be provided in an environment absent a quantum system 101, such as for generation, but not execution, of the quantum circuit based on the atomic system.

Discussion first turns briefly to the processor 306, memory 304 and bus 305 of the spin behavior analysis system 302. For example, in one or more embodiments, the spin behavior analysis system 302 can comprise the processor 306 (e.g., computer processing unit, microprocessor, classical processor and/or like processor). In one or more embodiments, a component associated with the spin behavior analysis system 302, as described herein with or without reference to the one or more figures of the one or more embodiments, can comprise one or more computer and/or machine readable, writable and/or executable components and/or instructions that can be executed by processor 306 to provide performance of one or more processes defined by such component(s) and/or instruction(s). In one or more embodiments, the processor 306 can comprise the obtaining component 312, quantum circuit generation component 314, partitioning component 316 and/or analysis component 318.

In one or more embodiments, the spin behavior analysis system 302 can comprise the computer-readable memory 304 that can be operably connected to the processor 306. The memory 304 can store computer-executable instructions that, upon execution by the processor 306, can cause the processor 306 and/or one or more other components of the spin behavior analysis system 302 (e.g., obtaining component 312, quantum circuit generation component 314, partitioning component 316 and/or analysis component 318) to perform one or more actions. In one or more embodiments, the memory 334 can store computer-executable components (e.g., obtaining component 312, quantum circuit generation component 314, partitioning component 316 and/or analysis component 318).

The spin behavior analysis system 302 and/or a component thereof as described herein, can be communicatively, electrically, operatively, optically and/or otherwise coupled to one another via a bus 305. Bus 305 can comprise one or more of a memory bus, memory controller, peripheral bus, external bus, local bus, quantum bus and/or another type of bus that can employ one or more bus architectures. One or more of these examples of bus 305 can be employed.

In one or more embodiments, the spin behavior analysis system 302 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical and/or quantum computing devices, communication devices and/or like devices), such as via a network. In one or more embodiments, one or more of the components of the spin behavior analysis system 302 and/or of the non-limiting system 300 can reside in the cloud, and/or can reside locally in a local computing environment (e.g., at a specified location(s)).

In addition to the processor 306 and/or memory 304 described above, the spin behavior analysis system 302 can comprise one or more computer and/or machine readable, writable and/or executable components and/or instructions that, when executed by processor 306, can provide performance of one or more operations defined by such component(s) and/or instruction(s).

Turning now to the additional components of the spin behavior analysis system 302 (e.g., obtaining component 312, quantum circuit generation component 314, partitioning component 316 and/or analysis component 318), generally, the spin behavior analysis system 302 can perform one or more operations to facilitate quantum circuit generation and atomic system simulation in correspondence with use of the quantum system 101.

The obtaining component 312 can receive, locate, find, determine and/or otherwise obtain a quantum job request 124 or other data (e.g., data and/or metadata) defining an atomic system, for use in constructing quantum circuit based on the atomic system. Such data can originate from a user entity of the spin behavior analysis system 302 and/or from external to the spin behavior analysis system 302. As described, above, the atomic system can comprise one or more radical pair systems with an arbitrary number of hyperfine coupling constants, i.e., an arbitrary number of magnetically equivalent spin-1/2 nuclei. Each radical pair system can comprise a set of identical molecules.

In one or more embodiments, the obtaining component 312 can obtain the Hamiltonian equations, eigenenergies, eigenbases, and/or Hamiltonian matrix construction to allow for parameterization of and generation of a quantum circuit, by the quantum circuit generation component 314, based on the atomic system. In one or more other embodiments, any of the Hamiltonian equations, eigenenergies, eigenbases, and/or Hamiltonian matrix construction can be generated by the obtaining component 312.

Hamiltonian Equations: For example, in a radical pair system of interest, the radical cation has multiple groups of magnetically equivalent spin-1/2 nuclei, i.e., an arbitrary number of hyperfine coupling (HFC) constants. It is assumed that the radical anion, being deuterated, has negligible HFC interactions. Additionally, the magnetic field acts on the spin-1/2 electronic subsystem of both the radical cation and anion. In summary, the overall Hamiltonian consists of three interaction terms, as shown at Equation 1, below.

$$Equation 1$$

$$H = {H}_{hfc} + {H}_{{B}_{1}} + {H}_{{B}_{2}} .$$

H_{hfc} is the HFC part of the respective Hamiltonian, which takes a set of aₖ (i.e., HFC constants) as an input.

In such case, the radical cation has N nuclei that separate into K sets of HFC constants a₁(n₁), a₂(n₂), . . . , aₖ(nₖ) such that Σₖ₌₁^{K}n_{K}=N, and n₁≤n₂≤ . . . ≤nₖ without loss of generality. The HFC part of the Hamiltonian H_{hfc} (e.g., the Hamiltonian matrix containing HFC constants) on the radical cation can be written as shown at Equation 2.

$$Equation 2$$

$${H}_{hfc} = {\sum }_{n = 1}^{N} {a}^{n} {I}_{n} \cdot {S}_{1} = {\sum }_{k = 1}^{K} {a}_{k} {I}_{total , k} \cdot {S}_{1} = {\sum }_{k = 1}^{K} {a}_{k} \frac{1}{2} [ {( {I}_{total , k} + {S}_{1} )}^{2} - {I}_{total , k}^{2} - {S}_{1}^{2} ]$$

In Equation 2, n is used as an index in tensor summation notation. The magnetic interaction terms of the Hamiltonian H_{B1} and H_{B2}, acting on the electronic subsystem of the radical cation and anion, respectively, can be written as shown at Equation 3.

$$Equation 3$$

$${H}_{{B}_{1 , 2}} = \frac{{μ}_{B} {g}_{1 , 2}}{ℏ} B \cdot {S}_{1 , 2} = \frac{{μ}_{B} {g}_{1 , 2}}{ℏ} {B}^{z} {S}_{1 , 2}^{z} = \frac{{μ}_{B} {g}_{1 , 2}}{2 ℏ} {BZ}_{1 , 2} .$$

In Equations 2 and 3, Iₙ is the nth nuclear spin in the radical cation, S₁ and S₂ are the electron spins in the radical cation and anion, respectively, aⁿ is the HFC constant of the nth nucleus in frequency units Hz, B is the external magnetic field (e.g., a constant external magnetic field), μ_{B} is the Bohr magneton, g₁ and g₂ are the g-factors of the unpaired electrons in the radical cation and anion, respectively, B^{z} is the unidirectional magnetic field strength along the z-axis in units of Tesla, and S₁^{z} and S₂^{z} are the Pauli-Z operators divided by a constant of 2 acting on the electronic subsystem of the radical cation and anion, respectively. In one or more embodiments, g-factors can be determine from an electron spin resonance database or measured experimentally using an electron spin resonance technique.

Eigenenergies and Eigenbases: Basis selection for the matrix representation of the overall Hamiltonian can be performed after a detailed analysis of the operators found in Equations 2 and 3. As such, each sub-component of the Hamiltonian H_{hfc}, as defined in Equation 4, is diagonal in the total-spin eigenbasis where all the nuclear spins corresponding to the HFC constant ax and the electronic spin of the radical cation are added together. H_{B1} is diagonal in any basis where the electronic spin of the radical cation is appended as individual spins {|↑ [symbol] , |↓ [symbol] }. Similarly, H_{B2} is diagonal in any basis where the electronic spin of the radical anion is appended as individual spins.

$$Equation 4$$

$${H}_{hfc , k} = {a}_{k} \frac{1}{2} [ {( {I}_{total , k} + {S}_{1} )}^{2} - {I}_{total , k}^{2} - {S}_{1}^{2} ] .$$

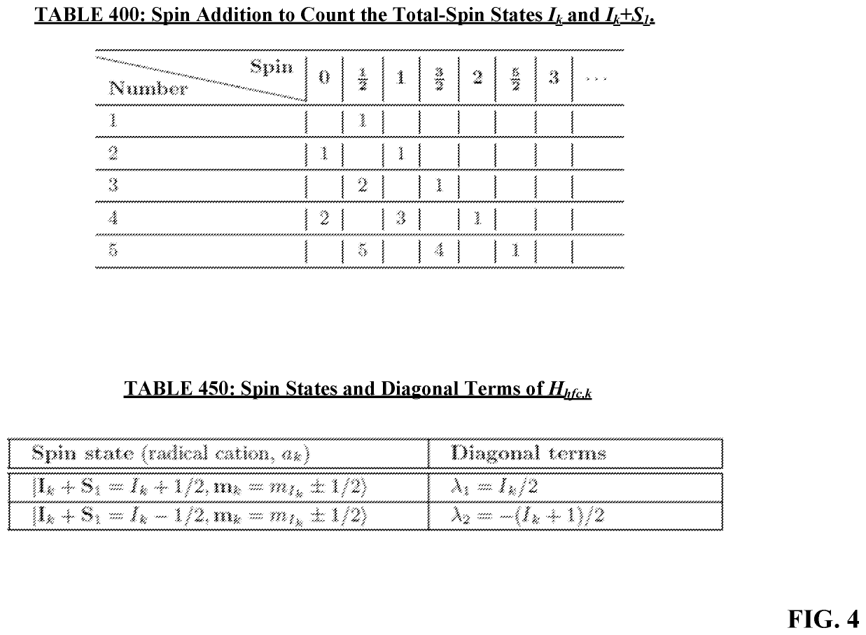

Before computing the eigenenergies and the number of corresponding degenerate eigenstates of H_{hfc,k}, an eigenbasis is generated, e.g., by the obtaining component 312, that respects the full symmetry of the original Hamiltonian, in order to minimize the sizes of the matrices to be diagonalized. To do this, the number of total-spin states is recorded using the quantum mechanical rules of spin addition as shown in Table 400 of FIG. 4.

In particular, illustrated at Table 400 is spin addition to count the total-spin states Iₖ and Iₖ+S₁. As an example, one can assume nₖ=4. To progressively count the number of states with a given total spin, one can start with a single spin-1/2 particle. Since adding another spin-1/2 expands the total range of spin by ±½, by iteratively adding all 4 nuclear spin-1/2s, one can arrive at the full electronic subsystem by the last row of Table 400. For each degenerate state with total-spin Iₖ, allowed magnetic numbers are m_{Ik}=Iₖ, Iₖ₋₁, . . . , −Iₖ.

The degenerate nuclear state counts d_{Ik} can also be expressed analytically in a compact equation for any nₖ using binomial coefficients as illustrated at Equation 5. One can consider even and odd cases of nₖ separately during the derivation, but the expression remains the same in both cases. If nₖ is even, then Iₖ=0, 1, 2, . . . , nₖ/2; and if nₖ is odd, then Iₖ=1/2, 3/2, 5/2, . . . , nₖ/2.

$$Equation 5$$

$${d}_{{I}_{k}} = ( \begin{matrix}{n}_{k} - 1 \\ {n}_{k} / 2 - 1 + {I}_{k}\end{matrix} ) - ( \begin{matrix}{n}_{k} - 1 \\ {n}_{k} / 2 + 1 + {I}_{k}\end{matrix} ) ,$$

where, by definition,

$$( \begin{matrix}a \\ b\end{matrix} ) = 0$$

if a<b.

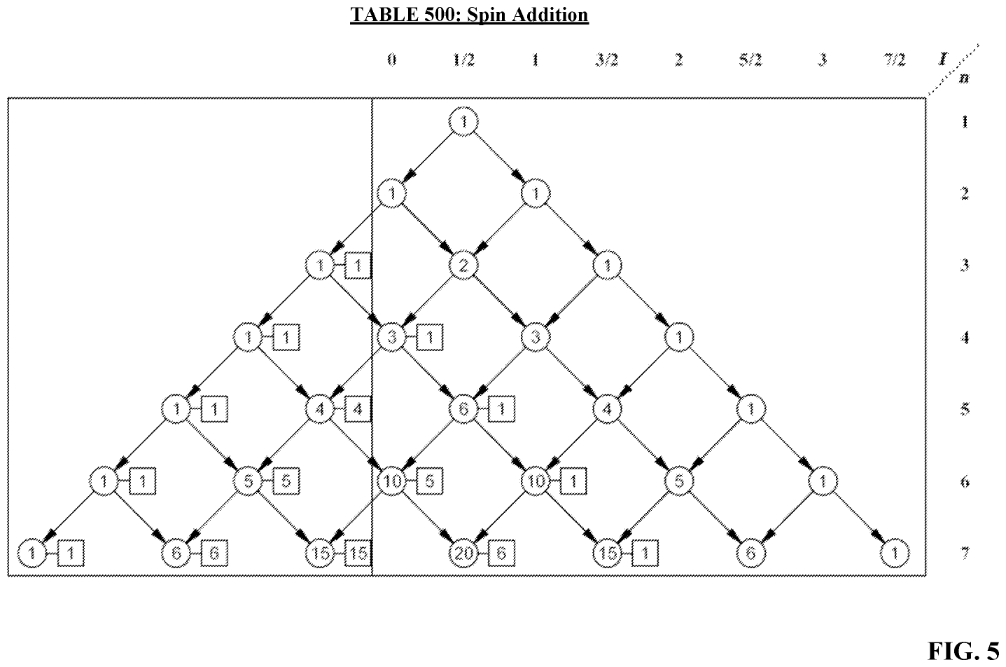

Derivation of Equation 5 can be obtained using Table 500 of FIG. 5, which illustrates the number of degenerate states with total-spin Iₖ for a given nₖ. As illustrated at Table 500, at every step, a new spin-1/2 is added to the system. A total spin/gives rise to I+½ and I−½, unless I=0 since total spin cannot be negative. This procedure corresponds to constructing a full Pascal's triangle (circle cells) and subtracting the ghost part of the triangle and its reflection (square cells) that actually do not exist due to the non-negativity constraint. Every entry in Pascal's triangle is a binomial coefficient, and thus one arrives at the expression in Equation 5 for d_{Ik}.

For denoting a quantum state with total spin Iₖ+S₁ including the nuclear and electronic subsystems, and whose “parent” total nuclear spin is Iₖ, the notation |Iₖ:Iₖ+S₁ [symbol] is employed. Note that a specific Iₖ can give rise to |Iₖ:Iₖ+½ [symbol] and |Iₖ:Iₖ−½ [symbol] , as long as Iₖ−½ is non-negative. The following terms of H_{hfc,k} can be computed:

$$Equations 6 to 9$$

$$〈 {I}_{k} : {I}_{k} + 1 / 2 \vert {( {I}_{total , k} + {S}_{1} )}^{2} \vert {I}_{k} : {I}_{k} + 1 / 2 〉 = ( {I}_{k} + 1 / 2 ) ( {I}_{k} + 3 / 2 ) \qquad ( 6 )$$

$$〈 {I}_{k} : {I}_{k} - 1 / 2 \vert {( {I}_{total , k} + {S}_{1} )}^{2} \vert {I}_{k} : {I}_{k} - 1 / 2 〉 = ( {I}_{k} - 1 / 2 ) ( {I}_{k} + 1 / 2 ) \qquad ( 7 )$$

$$〈 {I}_{k} : {I}_{k} + 1 / 2 \vert {I}_{total , k}^{2} \vert {I}_{k} : {I}_{k} + 1 / 2 〉 = 〈 {I}_{k} : {I}_{k} - 1 / 2 \vert {I}_{total , k}^{2} \vert {I}_{k} : {I}_{k} - 1 / 2 〉 = ( {I}_{k} ) ( {I}_{k} + 1 ) \qquad ( 8 )$$

$$〈 {I}_{k} : {I}_{k} + 1 / 2 \vert {S}_{1}^{2} \vert {I}_{k} : {I}_{k} + 1 / 2 〉 = 〈 {I}_{k} : {I}_{k} - 1 / 2 \vert {S}_{1}^{2} \vert {I}_{k} : {I}_{k} - 1 / 2 〉 = ( 1 / 2 ) ( 3 / 2 ) \qquad ( 9 )$$

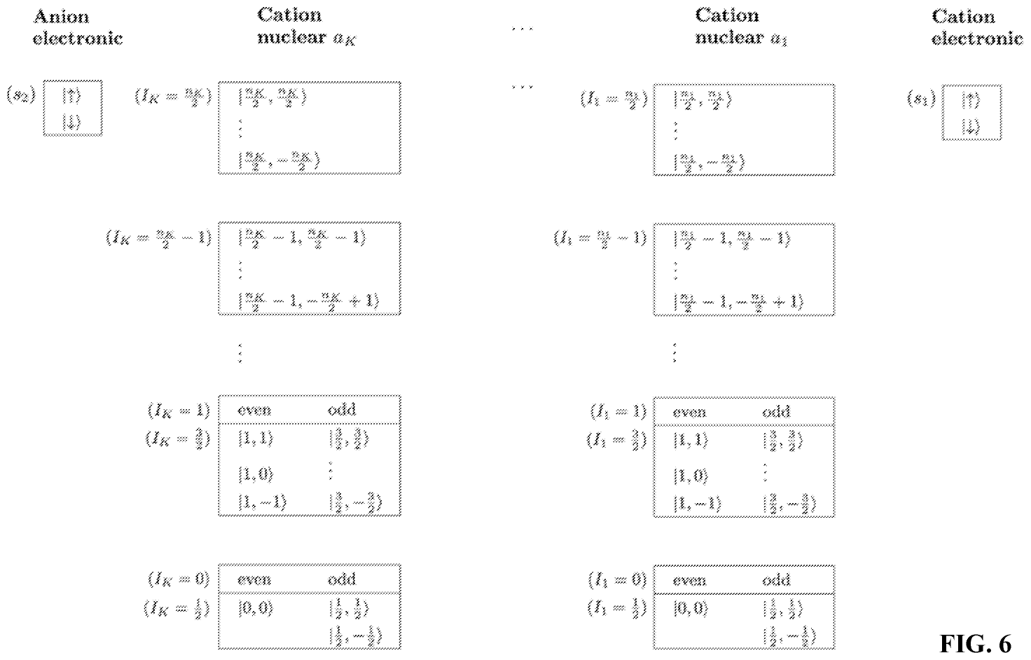

Because of a method employed for choosing bases (e.g., employing the Hamiltonian basis states of FIG. 6), H_{hfc} (e.g., the Hamiltonian matrix containing HFC constants) does not have any cross-diagonal terms between different Iₖ±½. The diagonal elements of H_{hfc,k} are as follows.

$$Equations 10 and 11$$

$$〈 {I}_{k} : {I}_{k} + 1 / 2 \vert {H}_{hfc , k} / {a}_{k} \vert {I}_{k} : {I}_{k} + 1 / 2 〉 = {I}_{k} / 2 \qquad ( 10 )$$

$$〈 {I}_{k} : {I}_{k} - 1 / 2 \vert {H}_{hfc , k} / {a}_{k} \vert {I}_{k} : {I}_{k} - 1 / 2 〉 = - ( {I}_{k} + 1 ) / 2 \qquad ( 11 )$$

For an arbitrary nₖ, basis states are parametrized as |Iₖ+S₁=Iₖ±½, mk=m_{Ik}±½). Possible total spin numbers are Iₖ∈{nₖ/2, nₖ/2−1, . . . , ½ or 0}. For a fixed Iₖ, possible magnetic numbers are m_{Ik}∈{Iₖ, Iₖ₋₁, . . . , −Iₖ Iₖ Results are summarized in Table 450 of FIG. 4. Table 450 applies to all Iₖ∈{nₖ/2, nₖ/2−1, . . . , ½ or 0}. Further, m_{Ik}∈{Iₖ, Iₖ₋₁, . . . , −1}. Each spin state is degenerate with state count di from Equation 5.

H_{B1} and H_{B2} are trivially diagonal in the individual electronic degrees of freedom. Also, have [symbol] ↓|H_{B1,2}|↓ [symbol] =b_{1,2} and [symbol] ↑|HB_{1,2}|↑ [symbol] =−b_{1,2}, where b_{1,2}=(μ_{Bg1,2}B)/(2 h).

This analysis shows that a convenient basis, in which the overall Hamiltonian from Equation 1 shall be expressed, is the tensor product of total spin states on each different group of magnetically equivalent nuclei, and the individual spin states on the electronic degrees, parametrized as |s₂ [symbol] |Iₖ [symbol] |Iₖ₋₁ [symbol] . . . |I₁ [symbol] |s₁ [symbol] . Following the above analysis, the eigenbases of different components H_{hfc,k} can be rotated onto this common basis using the theory of Clebsch-Gordan coefficients, as will be explained below.

Hamiltonian Matrix Construction: The overall Hamiltonian H=H_{hfc}+H_{B1}+H_{B2} is written as a matrix in the full basis shown at FIG. 6. This basis order is consistently followed throughout the matrix construction, such as by the obtaining component 312.

At FIG. 6, illustrated is an ordered list of Hamiltonian basis states. Nuclear states are of form |Iₖ, m_{Ik}). The basis consists of all possible ordered permutations of the states in the table. For instance, first state is |↑ [symbol] |n_{K}/2, n_{K}/2 [symbol] . . . |n₁/2, n_{K}/2 [symbol] |↑ [symbol] , second|↑ [symbol] |n_{K}/2, n_{K}/2 [symbol] . . . |nₖ/2, n_{K}/2 [symbol] |↓ [symbol] , third |↑ [symbol] |n_{K}/2, n_{K}/2 [symbol] . . . |n_{K}/2, n_{K}/2−1)|↑ [symbol] , and so on. Degeneracies of the states are omitted for simplicity. Exact multiplicities of the blocks (Iₖ=K, . . . , 1) can be computed using Equation 5.

To express the Hamiltonian in this basis, one can make use of quantum mechanical rules of spin addition. The corresponding Clebsch-Gordan coefficients for adding the electronic spins appear below.

Recall that Iₖ denotes a possible, specific total nuclear spin state of n_{K} spin-½ nuclei corresponding to HFC constant ax, i.e., Iₖ∈{n_{K}/2, n_{K}/2−1, . . . , ½ or 0}. The Hamiltonian matrix components H_{hfc,k} in the basis listed in FIG. 6 are written as follows.

Equation 12: H_{hfc,k}=aₖ×UₖΛₖUₖ, where Λₖ are the diagonal matrices corresponding to nuclear spins, and Uₖ are the basis change matrices constructed, such as by the quantum circuit generation component 314, with Clebsch-Gordan coefficients. Note that these matrices are both unitary and Hermitian, and therefore U_{Ik}′=Uₖ.

For a specific block (Iₖ) from FIG. 6, U_{Ik}′ and Λ_{Ik}′ acting on the corresponding subspace {Iₖ, s₁} are as follows. λ₁, λ₂ are defined in FIG.>450 of FIG. 5, and c_{m,a} and c_{m,b} below.

That is, taking a brief detour regarding the Clebsch-Gordan coefficients, for a specific block (Iₖ) from FIG. 1, U_{Ik}′ is simply the Clebsch-Gordan table for spin addition Iₖ⊕½. For a fixed Iₖ, two nuclear states with magnetic numbers m and m−1 can get mixed through coefficients c_{m,a} and c_{m,b}.

$$Equation B 1$$

$${U}_{{I}_{k}}^{′} = [ \begin{matrix}1 & & & & \\ & \begin{matrix}{c}_{{I}_{k} , a} & {c}_{{I}_{k} , b} \\ {c}_{{I}_{k} , b} & - {c}_{{I}_{k} , a}\end{matrix} & & & \\ & & ⋱ & & \\ & & & \begin{matrix}{c}_{- {I}_{k} + 1 , a} & {c}_{- {I}_{k} + 1 , b} \\ {c}_{- {I}_{k} + 1 , b} & - {c}_{- {I}_{k} + 1 , a}\end{matrix} & \\ & & & & 1\end{matrix} ] \begin{matrix}\vert {I}_{k} , {I}_{k} 〉 \vert ↑ 〉 \\ \vert {I}_{k} , {I}_{k} 〉 \vert ↓ 〉 \\ \vert {I}_{k} , {I}_{k} - 1 〉 \vert ↑ 〉 \\ ⋮ \\ \vert {I}_{k} , - {I}_{k} + 1 〉 \vert ↓ 〉 \\ \vert {I}_{k} , - {I}_{k} 〉 \vert ↑ 〉 \\ \vert {I}_{k} , - {I}_{k} 〉 \vert ↓ 〉\end{matrix} .$$

Coefficients c_{m,a} and c_{m,b} are parameterized as follows in Equation B2.

$$Equation B 2$$

$${c}_{m , a} = \sqrt{\frac{{I}_{k} - m + 1}{2 {I}_{k} + 1}} , {c}_{m , b} = \sqrt{\frac{{I}_{k} + m}{2 {I}_{k} + 1}} .$$

Turning back to expression of the Hamiltonian and use of quantum mechanical rules of spin addition, U_{Ik}′ and Λ_{Ik}′ can later be utilized to construct Uₖ and Λₖ acting on the whole Hilbert space {Iₖ, Iₖ₋₁, . . . , I₁, s₁} of the radical cation. Note Equations 13A and 13B, below.

$$Equation 13 A$$

$${U}_{{I}_{k}}^{′} = [ \begin{matrix}1 & & & & \\ & \begin{matrix}{c}_{{I}_{k} , a} & {c}_{{I}_{k} , b} \\ {c}_{{I}_{k} , b} & - {c}_{{I}_{k} , a}\end{matrix} & & & \\ & & ⋱ & & \\ & & & \begin{matrix}{c}_{- {I}_{k} + 1 , a} & {c}_{- {I}_{k} + 1 , b} \\ {c}_{- {I}_{k} + 1 , b} & - {c}_{- {I}_{k} + 1 , a}\end{matrix} & \\ & & & & 1\end{matrix} ]$$

$$Equation 13 B$$

$${Λ}_{{I}_{k}}^{′} = [ \begin{matrix}{λ}_{1} & & & & & & \\ & {λ}_{1} & & & & & \\ & & {λ}_{2} & & & & \\ & & & {λ}_{1} & & & \\ & & & & ⋱ & & \\ & & & & & {λ}_{2} & \\ & & & & & & {λ}_{1}\end{matrix} ] \begin{matrix}\vert {I}_{k} , {I}_{k} 〉 \vert ↑ 〉 \\ \vert {I}_{k} , {I}_{k} 〉 \vert ↓ 〉 \\ \vert {I}_{k} , {I}_{k} - 1 〉 \vert ↑ 〉 \\ \vert {I}_{k} , {I}_{k} - 1 〉 \vert ↓ 〉 \\ ⋮ \\ \vert {I}_{k} , - {I}_{k} 〉 \vert ↑ 〉 \\ \vert {I}_{k} , - {I}_{k} 〉 \vert ↓ 〉\end{matrix}$$

From the theory of Clebsch-Gordan coefficients, the states that mix during spin addition are |Iₖ, mₖ [symbol] |↓ [symbol] and |Iₖ, mₖ₋₁ [symbol] |↑ [symbol] for some allowed magnetic number mx, resulting in total spin states |Iₖ+½, mₖ−½ [symbol] and |Iₖ−½, mₖ−½ [symbol] . U_{Ik}′ allows for switching back and forth between these two bases.

Next, to set up Uₖ, certain observations can be made with k=1, which generalizes to all k=1, . . . , K. Note that Uₖ and Λₖ from Equation 12 are defined on the entirety of the radical cation basis states from FIG. 6, and this Hilbert space has dimension 2(N+1). On this space, eigenstates of H_{hfc,1} that mix under U₁ are |Iₖ, mₖ [symbol] . . . |I₂, m₂ [symbol] |I₁+½, m₁−½ [symbol] and |Iₖ, mₖ [symbol] . . . |I₂, m₂ [symbol] |I₁−½, m₁−½ [symbol] , resulting in a linear combination of states |Iₖ, mₖ) . . . |I₂, m₂ [symbol] |I₁, m₁ [symbol] |↓ [symbol] and |Iₖ, mₖ [symbol] . . . |I₂, m₂ [symbol] |I₁, m₁−1 [symbol] |↑ [symbol] from FIG. 6.

It can be observed that in the chosen basis [symbol] ψ|H_{hfc,1}|Φ [symbol] =0 if |Iₖ, mₖ [symbol] . . . |I₂, m₂)_{ψ}≠|Iₖ, mₖ [symbol] . . . |I₂, m₂)_{Φ} due to orthogonality.

Therefore, U₁=1⊗U_{I1}′, where 1 is an identity matrix on the {I_{K}, . . . , I₂} subspace including the degeneracies. Similarly for other k, Uₖ are scattered copies of U_{Ik}′, where the nonzero matrix elements are arranged according to the order of basis states shown in FIG. 6, and zero matrix elements are once again identified via orthogonality.

In discussion below, relative to one or more processes that can be performed by the quantum circuit generation component 314, these observations can be extended to all k to construct, e.g., by the quantum circuit generation component 314, Uₖ from the corresponding U_{Ik}′, by algorithmically identifying the nonzero matrix indices. In addition, different Hamiltonian partitioning strategies that can be employed by the partitioning component 316 are discussed, allowing for an efficient simulation on the quantum system 101.

Quantum Circuit Generation: Turning next to the quantum circuit generation component 314, based on the exact parameters of g-factors, HFCs and/or magnetic field strength (e.g., constant, external magnetic field strength), determined as above, a quantum circuit representing the atomic system to be analyzed can be generated.

First, the initial state ρ₀ undergoing the described Hamiltonian evolution can be considered. On the nuclear subsystem, it is the maximally mixed state at the (effectively infinite) temperature at which the experiment takes place. The initial state of the electronic subsystem is the singlet state due to spin conservation laws. Equation 14 shows the initial state of the full system including both nuclear and electronic degrees of freedom.

$$Equation 14$$

$${ρ}_{0} = \frac{{2}^{N}}{} ⊗ \vert S 〉 〈 S \vert , where \vert S 〉 = \frac{\vert ↑ ↓ 〉 - \vert ↓ ↑ 〉}{\sqrt{2}}$$

The quantity of interest for measurement is the probability S(t) of the electronic subsystem to be in a singlet state as a function of time t. To initiate the nuclear subsystem on the quantum system 101, the quantum circuit generation component 314 can make use of ancilla qubits in the quantum circuit; otherwise only pure states can be initiated. In this latter case, because every

$${Π}_{k = 1}^{K} ⌊ \frac{{n}_{k} + 2}{2} ⌋ ⌊ \frac{{n}_{k} + 3}{2} ⌋$$

nuclear state is equally likely, one would need to run the simulation on every initial state permutation from FIG. 6 and build a weighted average of the individual outcomes using the state counts from Equation 5, which would be very costly in terms of time, power, memory and quantum system usage. Conversely, with the use of ancilla qubits, the spin behavior analysis system 302 can construct the maximally mixed state on a desired subspace in a single initiation step, as illustrated below. Because of different symmetries found in the Hamiltonian, the matrix subdivides into multiple non-interactive blocks, and each can be simulated separately. These can then be combined in a classical post-processing step.

Relative to constructing the maximally mixed state on a desired subspace in a single initiation step (e.g., by the quantum circuit generation component 314), quantum state purification states that a mixed state can be represented as a pure state if it is entangled with an ancilla system A. Specifically, the purification of the maximally mixed state is the maximally entangled state as shown at Equation C1.

$$\vert Ψ 〉 = \frac{1}{\sqrt{{2}^{N}}} {\sum }_{n = 0}^{{2}^{N} - 1} \vert n 〉 \vert n {〉}_{A} . \qquad Equation C1$$

As such, the maximally mixed state can be recovered by tracing out the ancilla system A as follows at Equation C2.

$${ρ}_{0} = \frac{1}{{2}^{N}} ⊗ \vert S \text{〉 〈} S \vert = {Tr}_{A} \{ \frac{1}{{2}^{N}} {\sum }_{n = 0}^{{2}^{N} - 1} {\sum }_{m = 0}^{{2}^{N} - 1} \vert n \text{〉 \textbar} n {〉}_{A} 〈 m \text{\textbar 〈} m {\vert}_{A} \} ⊗ \vert S \text{〉 〈} S \vert . \qquad Equation C2$$

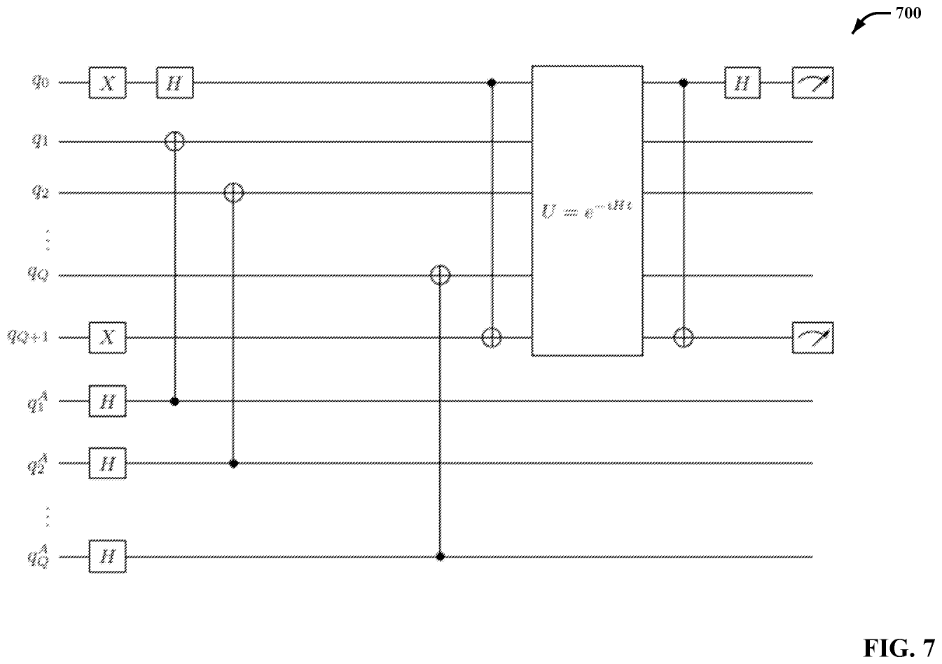

Referring briefly to FIG. 7, illustrated is an example mixed state simulation circuit that can be employed by the quantum circuit generation component 314. That is, q₀ represents the electronic subsystem of the radical cation and q_{Q+1} that of the radical anion. These are initiated in the singlet state. Qubits q1, q₂, . . . , q_{Q} stand for the nuclear states of the radical cation. The number of nuclear qubits Q depends on the number of total nuclear states in the specific Hamiltonian partition being simulated. Q nuclear qubits are maximally entangled with Q ancilla qubits to initiate the maximally mixed state on the nuclear degrees of freedom. After H matrix is set up, they can be provided into a respective Hamiltonian gate class from of a respective compiler communicatively coupled to the hybrid non-limiting system 300 to compile them into unitary gate sequences. This class uses the generic isometry decomposition method for unitaries on three or more qubits, and the KAK decomposition (e.g., a Cartan Decomposition) on two-qubit unitaries. A single qubit evolution is expressed with a generic U3-gate. At the end of the simulation, singlet state probabilities can be measured, e.g., employing the measurement readout component 112. The KAK decomposition can allow operations on 2-qubit unitary evolutions to be expressed as a combination of single qubit evolutions with a U3 gate and two-qubit CNOT gates.

Partitioning: Turning next to the partitioning component 316 (e.g., to use of the partitioning component 316 by the quantum circuit generation component 314), the partitioning component 316 can generally reduce the number of qubits comprised by the set of qubits to be employed by generating a plurality of partitions each comprising respective Hamiltonian states with their corresponding degeneracies, wherein each shot a set of shots executed at the quantum device to operate the quantum circuit comprises less than all Hamiltonian states of the quantum circuit.

Put another way, the partitioning component 316 can account for the direct correspondence of (a) the number of qubits needed to operate the quantum circuit and (b) the number of sets of hyperfine coupling constants (e.g., the number of groups of magnetically equivalent nuclei to which the sets of hyperfine coupling constants relate). That is, as the number of sets of hyperfine coupling constants increases, so does the number of qubits needed to operate the corresponding quantum circuit based on the sets of hyperfine coupling constants. Accordingly, the partitioning component 316 can provide partitioning of the Hamiltonian states defining the quantum circuit, and thus partitioning of the quantum circuit, to allow for operation of two or more shots at the quantum system to complete operation of the total quantum circuit at the quantum system 101.

Discussion now turns to a pair of example partitioning method examples.

A first example partitioning method comprises selecting nuclear states with fixed total spins from each group of magnetically equivalent nuclei of the arbitrary number of groups of magnetically equivalent nuclei of the atomic system to be analyzed/being analyzed.

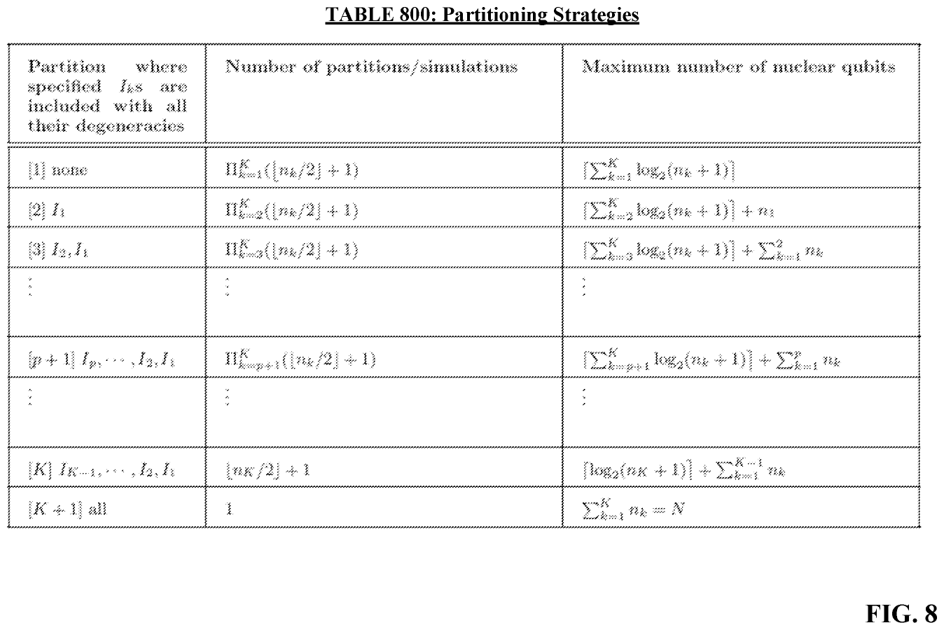

The example at line 1 of Table 800 of FIG. 8 is described below, in that the other lines of the Table 800 can be obtained in an analogous manner.

As illustrated at Table 800, trade-offs of different partitioning strategies are provided with an index label in brackets for certain key strategies mentioned in the text. A number of qubits is reported for the largest partition in the given method (e.g., given line). In general, reducing the partition number count by one polynomial degree has the penalty that one logarithmic qubit cost in the sum increases to linear. Note that in a mixed state simulation circuit with Q qubits on the nuclear subsystem, there are 2Q+2 qubits in total. If not making use of the mixed state circuit (e.g., FIG. 7) and running the simulation on pure nuclear states in partitioning strategy [1] (e.g., line 1), then Q+2 qubits could be employed, but one simulation per different nuclear state |I_{K}, m_{Ik} [symbol] . . . |I₁, m_{I1} [symbol] would need to be run. Since there are

$${\prod }_{k = 1}^{K} ⌊ \frac{{n}_{k} + 2}{2} ⌋ ⌊ \frac{{n}_{k} + 3}{2} ⌋$$

such states, the simulation cost would increase quadratically.

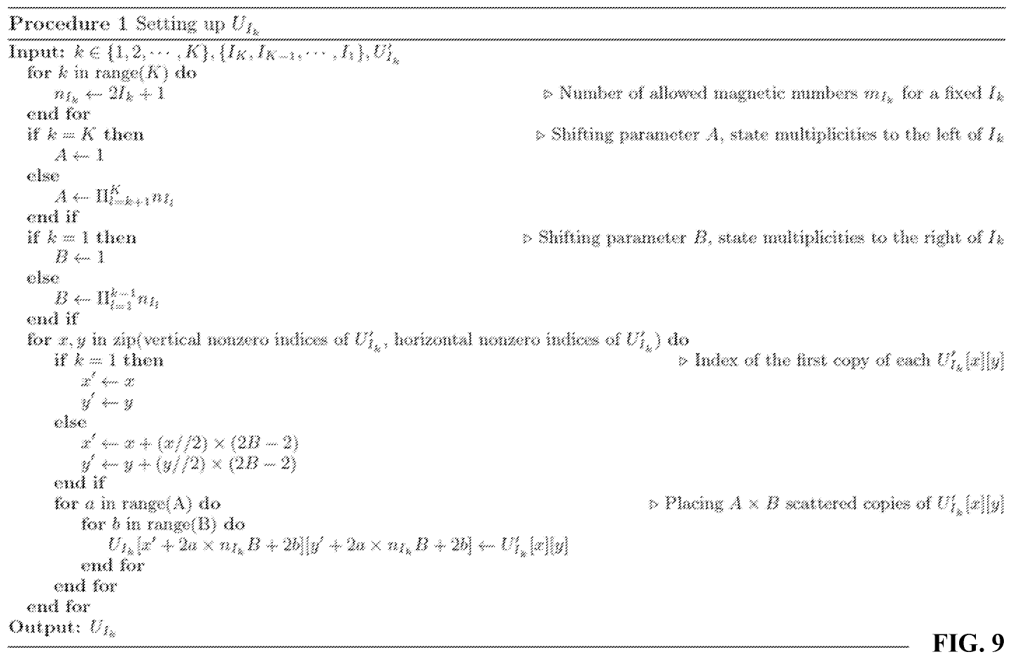

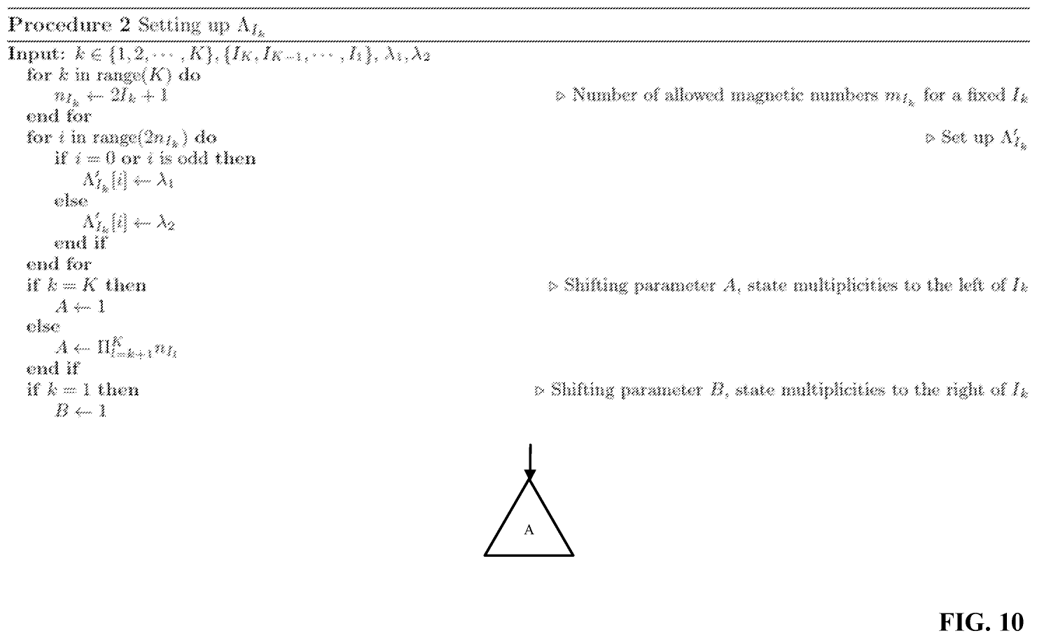

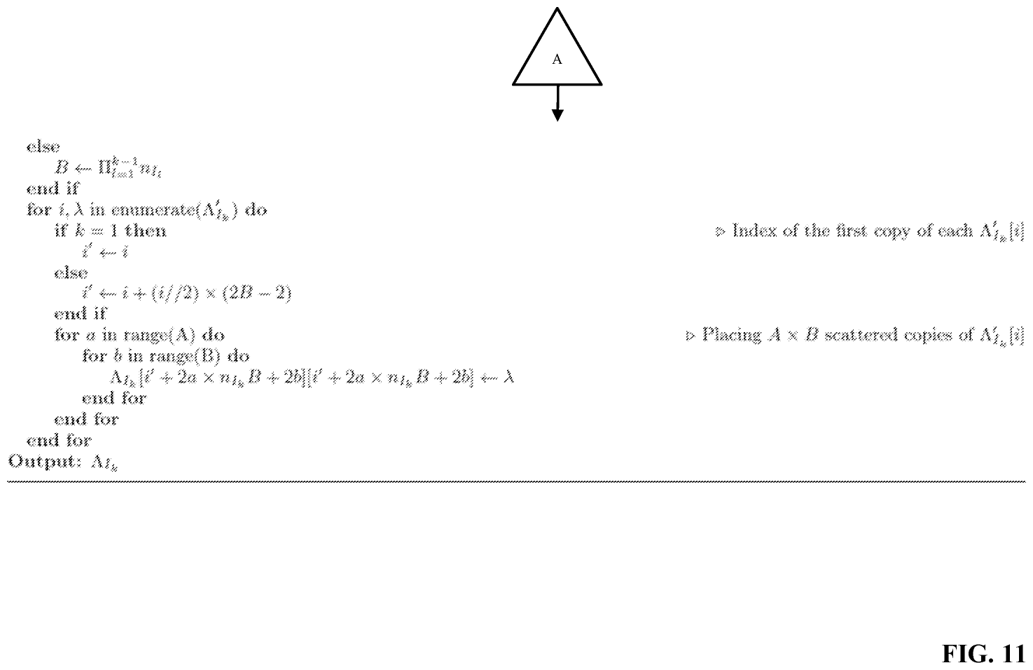

Turning now to the example of line 1 of Table 800, the first step is to list every possible combination of radical cation state blocks with fixed IK as shown in FIG. 6. Specifically, the first set is (I_{K}=n_{K}/2) . . . (I₁=n₁/2) (s₁), second (I_{K}=n_{K}/2) . . . (I₁=n₁/2−1) (s₁), third (I_{K}=n_{K}/2) . . . (I₁=n₁/2−2) (s₁), and so on. The simulation is run on each of these combinations. The part of the unitaries Uₖ that act on the subset of basis states containing solely fixed total spins {I_{K}, I_{K}−1, . . . , I₁, s₁} is denoted as U_{Ik}, and the corresponding diagonal matrix Λ_{Ik}. The matrix U_{Ik} can be set up using Procedure 1 illustrated at FIG. 9. The matrix Λ_{Ik} can be set up using Procedure 2 illustrated at FIGS. 10 and 11. These procedures involve creating scattered and multiplied copies of U_{Ik} and Λ_{Ik} from Equation 13 since these matrices do not have a compact expression. The locations of the nonzero matrix elements are found by identifying the interacting and non-interacting states under the H_{hfc,k} parts of the Hamiltonian, following the rules of spin addition.

The entries are arranged following the above-defined consistent choice of state ordering, e.g., relative to FIG. 6.

This results in the following Hamiltonian matrix H_{hfc}+H_{B1} on the {I_{K}, I_{K-1}, . . . , I₁, s₁} subspace of the radical cation. This subspace is of dimension d=2Πₖ₌₁^{K}(2Iₖ+1). H_{B2} acts on the electron of the radical anion, i.e., on the {s₂} subspace. For the following, let Iₙ denote an n×n identity matrix, and 0ₙ an n×n all-zero matrix.

$${H}_{hfc} + {H}_{{B}_{1}} = {\sum }_{k = 1}^{K} {a}_{k} \times {U}_{{I}_{k}} {Λ}_{{I}_{k}} {U}_{{I}_{k}} - {b}_{1} {1}_{\frac{d}{2}} ⊗ Z , {H}_{{B}_{2}} = - {b}_{2} Z . \qquad Equation 15$$

Two sets of z=2┌log₂d┐−d zeros are appended to this matrix to round it up to the nearest power of 2 and to separate the positive and negative entries of H_{B2}, resulting in Equation 16.

$$H = [ \begin{matrix}{H}_{hfc} + {H}_{{B}_{1}} + {b}_{2} {1}_{d} & & & \\ & {0}_{z} & & \\ & & {H}_{hfc} + {H}_{{B}_{1}} + {b}_{2} {1}_{d} & \\ & & & {0}_{z}\end{matrix} ] \qquad Equation 16$$

The unitary evolution U=e^{-iHt} can then be directed to run, e.g., by the quantum circuit generation component 314 directing the quantum operation component 103, on each {s₂, I_{K}, I_{K-1}, . . . , I₁, s₁} combination using the circuit in FIG. 7 and classically post-process the individual singlet state probability curves for the overall S(t) in the classical post-processing section provided below.

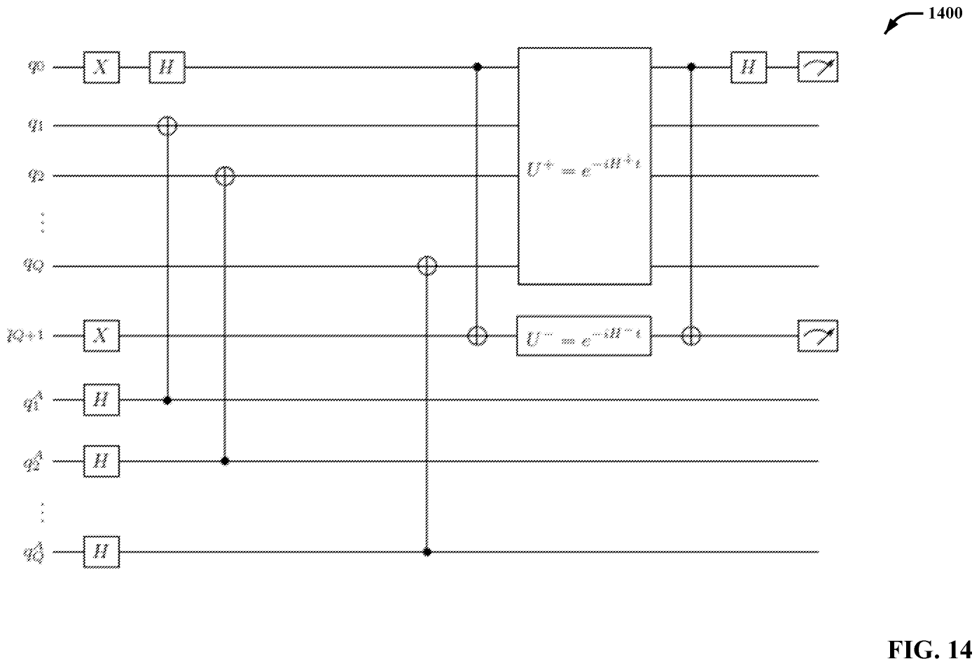

Because of the appended zeros, it is in general not possible to split the Hamiltonian circuit into parts acting on the radical cation H+ and anion H−. This only becomes possible in case of equal g-factors as shown in FIG. 14.

For example, turning to FIG. 14, In case of equal g-factors, i.e., b₁=b₂, the Hamiltonian can be split into two parts and zeros appended slightly differently. This method works in case of b₁=b₂ because the initial singlet state on the electronic degrees falls in entries where H_{B1} and H_{B2} cancel each other out. The modification is as follows.

The {I_{K}, I_{K-1}, . . . , I₁, s₁} subspace of the radical cation is of dimension d=2Πₖ₌₁^{K}(2Iₖ+1). Thus z=2┌log₂d┐−d zeros can be appended to round this dimension up to the nearest power of 2. Then U⁺=exp(−iH⁺t) can be mapped to the qubits representing the radical cation. U⁻=exp(−iH⁻t) acts on the single qubit representing the radical anion. As two parts result as represented by Equations D1 and D2.

$${H}^{+} = [ \begin{matrix}{H}_{hfc} & \\ & {0}_{z}\end{matrix} ] + {H}_{{B}_{1}} , {H}^{-} = {H}_{{B}_{2}} , where \qquad Equation D1$$

$${H}_{hfc} = {\sum }_{k = 1}^{K} {a}_{h} \times {U}_{{I}_{k}} {Λ}_{{I}_{k}} {U}_{{I}_{k}} , {H}_{{B}_{1}} = - {b}_{1} {1}_{\frac{( d + s )}{2}} ⊗ Z , {H}_{{B}_{2}} = - {b}_{2} Z . \qquad Equation D2$$

The unitary evolution U⁻⊗U⁺ is run on each {s₂, I_{K}, I_{K-1}, . . . , I₁, s₁} combination using the circuit in FIG. 14 and classically post-process the individual singlet state probability curves for the overall S(t).

In particular, FIG. 14 illustrates an alternative mixed state simulation circuit in case of equal g-factors. The Hamiltonian can be split into two explicit parts H+ and H−. This way, H+ can compile faster with a compiler communicatively coupled to the quantum system 101. H− is a scaled Pauli-Z operator, and therefore U⁻ is simply a Z-rotation.

Discussion now turns to another partitioning method example incorporating nuclear states with different total spins in a single simulation.

There are certain trade-offs among different ways of partitioning the Hamiltonian, which are discussed next. In general, if more states are included per Hamiltonian partition, fewer number of simulations can be run, the S(t) curves of which need are then to be classically combined (e.g., aggregated) in a later classical-based step. However, this increases the number of qubits employed and increases the Hamiltonian matrix size that needs to be complex-exponentiated and compiled into one and two-qubit gate sequences. Since qubits are considered an expensive resource for near-term hardware, one should analyze these trade-offs for the system being simulated and decide on the most reasonable partitioning strategy given the available computing resources.

Other Hamiltonian partitioning strategies can be considered as follows. Referring to FIG. 6 again, recall that with the first partitioning method [1], discussed above, every possible combination of the set {I_{K}, I_{K-1}, . . . , I₃, I₂, I₁, s₁} is considered with fixed total spins a partition of the Hamiltonian. There are Πₖ₌₁^{K}(└nₖ/2┘+1) such partitions. Instead using a second partitioning method [2] (e.g., line 2 of Table 800 of FIG. 8), the quantum circuit generation component 314 (based on the partitioning) can generate not just one, but all, possible total-spin//states, including all the degenerate counts d_{Ik} from Equation 5. Now, there is a single//block that can be appended to the remaining {I_{K}, I_{K-1}, . . . , I₃, I₂, s₁} combinations. This reduces the total partition count Πₖ₌₁^{K}(└nₖ/2┘+1), but increases the number of qubits since multiple copies of the I₁ states are included in each partition. The exact degeneracies from Equation 5 are included in this way of partitioning the Hamiltonian states to enable the one or more classical post-processing steps, described below relative to the analysis component 318.

This process can be repeated iteratively on any desired I_{K}. If all states I₁, I₂, . . . , Iₚ are included with their degenerate counts in the partition (line [p+1] from Table 800), then the total number of partitions, on the mixed-state simulation circuit are separately run, reduces to Πₖ₌₁^{K}(└nₖ/2┘+1). In the limit p=K (line K+1 from Table 800), this corresponds to listing all 2^{N+1} radical cation states and having one mixed-state circuit with the maximum qubit requirement.

Comparing the qubit-count/partition-number trade-offs of different strategies in Table 800, it is noted that having Q qubits for the radical cation is not only costly in the qubit count, but also means that U is a 2Q+1×2Q+/matrix that needs to be decomposed into a sequence of available one and two-qubit gates on the compiler. This point also should be taken into account when selecting an appropriate partitioning strategy.

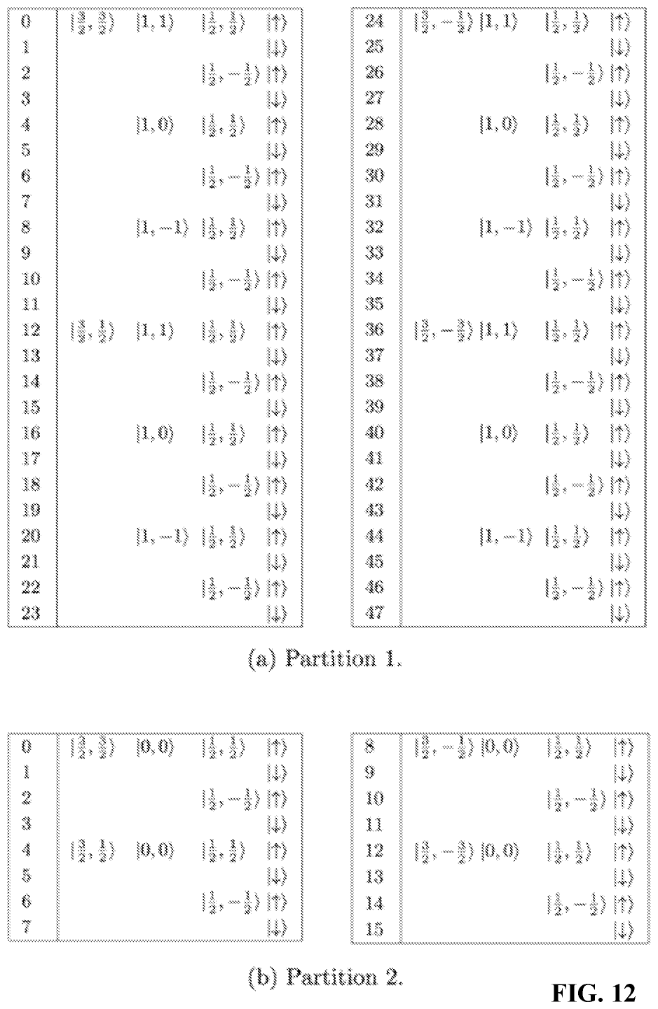

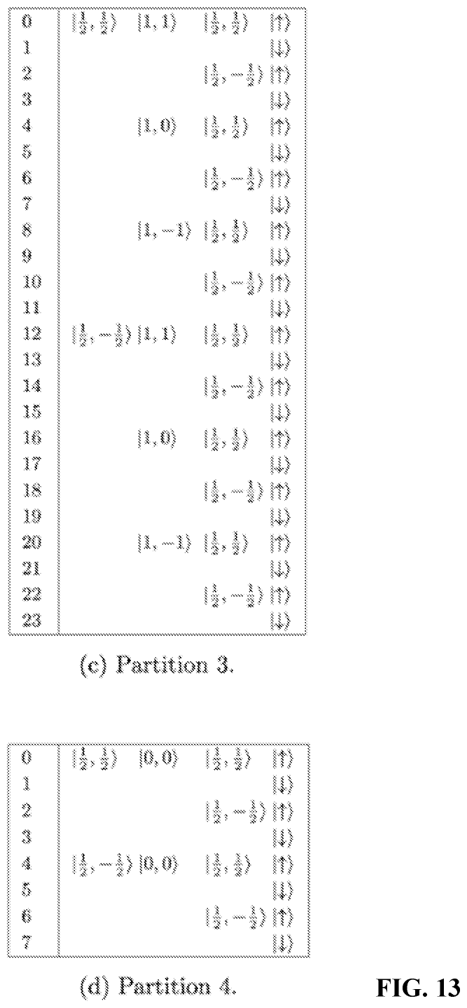

Example Case: Explicit matrices can be constructed for a case study of K=3, with n₃=3, n₂=2, n₁=1, and thus N=6. The Hamiltonian partitions are P₁={I₃=3/2, I₂=1, I₁=½, s₁}. P₂={I₃=3/2, I₂=0, I₁=½, s₁}, P₃={I₃=½, I₂=1, I₁=½, s₁} and P₄={I₃=½, I₂=0, I₁=½, s₁} as shown in FIGS. 12 and 13. Partition 1 is P₁, Partition 2 is P₂, Partition 3 is P₃ and Partition 4 is P₄ at FIGS. 12 and 13. Relative to FIGS. 12 and 13, the matrices U_{Ik} and Λ_{Ik} can be constructed in the illustrated basis order.

An explicit construction of U_{Ik} and Λ_{Ik} for P₃={I₃=½, I₂=1, I₁=½, s₁} is provided below as an example at Equations 17 to 22. Procedures 1 and 2 of FIGS. 9 to 11 can produce these matrices generically. All non-specified matrix elements are zero due to orthogonality.

### Equations 17 to 22:

$${Λ}_{{I}_{1}} [ 0 ] [ 0 ] = {Λ}_{{I}_{1}} [ 4 ] [ 4 ] = {Λ}_{{I}_{1}} [ 8 ] [ 8 ] = {Λ}_{{I}_{1}} [ 12 ] [ 12 ] = {Λ}_{{I}_{1}} [ 16 ] [ 16 ] = {Λ}_{{I}_{1}} [ 20 ] [ 20 ] = 0.25 \qquad ( 17 )$$

$${Λ}_{{I}_{1}} [ 1 ] [ 1 ] = {Λ}_{{I}_{1}} [ 5 ] [ 5 ] = {Λ}_{{I}_{1}} [ 9 ] [ 9 ] = {Λ}_{{I}_{1}} [ 13 ] [ 13 ] = {Λ}_{{I}_{1}} [ 17 ] [ 17 ] = {Λ}_{{I}_{1}} [ 21 ] [ 21 ] = 0.25$$

$${Λ}_{{I}_{1}} [ 2 ] [ 2 ] = {Λ}_{{I}_{1}} [ 6 ] [ 6 ] = {Λ}_{{I}_{1}} [ 10 ] [ 10 ] = {Λ}_{{I}_{1}} [ 14 ] [ 14 ] = {Λ}_{{I}_{1}} [ 18 ] [ 18 ] = {Λ}_{{I}_{1}} [ 22 ] [ 22 ] = - 0.75$$

$${Λ}_{{I}_{1}} [ 3 ] [ 3 ] = {Λ}_{{I}_{1}} [ 7 ] [ 7 ] = {Λ}_{{I}_{1}} [ 11 ] [ 11 ] = {Λ}_{{I}_{1}} [ 15 ] [ 15 ] = {Λ}_{{I}_{1}} [ 19 ] [ 19 ] = {Λ}_{{I}_{1}} [ 23 ] [ 23 ] = 0.25$$

$${U}_{{I}_{1}} [ 0 ] [ 0 ] = {U}_{{I}_{1}} [ 4 ] [ 4 ] = {U}_{{I}_{1}} [ 8 ] [ 8 ] = {U}_{{I}_{1}} [ 12 ] [ 12 ] = {U}_{{I}_{1}} [ 16 ] [ 16 ] = {U}_{{I}_{1}} [ 20 ] [ 20 ] = 1 \qquad ( 18 )$$

$${U}_{{I}_{1}} [ 1 ] [ 1 ] = {U}_{{I}_{1}} [ 5 ] [ 5 ] = {U}_{{I}_{1}} [ 9 ] [ 9 ] = {U}_{{I}_{1}} [ 13 ] [ 13 ] = {U}_{{I}_{1}} [ 17 ] [ 17 ] = {U}_{{I}_{1}} [ 21 ] [ 21 ] = \sqrt{1 / 2}$$

$${U}_{{I}_{1}} [ 2 ] [ 2 ] = {U}_{{I}_{1}} [ 6 ] [ 6 ] = {U}_{{I}_{1}} [ 10 ] [ 10 ] = {U}_{{I}_{1}} [ 14 ] [ 14 ] = {U}_{{I}_{1}} [ 18 ] [ 18 ] = {U}_{{I}_{1}} [ 22 ] [ 22 ] = \sqrt{1 / 2}$$

$${U}_{{I}_{1}} [ 1 ] [ 2 ] = {U}_{{I}_{1}} [ 5 ] [ 6 ] = {U}_{{I}_{1}} [ 9 ] [ 10 ] = {U}_{{I}_{1}} [ 13 ] [ 14 ] = {U}_{{I}_{1}} [ 17 ] [ 18 ] = {U}_{{I}_{1}} [ 21 ] [ 22 ] = \sqrt{1 / 2}$$

$${U}_{{I}_{1}} [ 2 ] [ 1 ] = {U}_{{I}_{1}} [ 6 ] [ 5 ] = {U}_{{I}_{1}} [ 10 ] [ 9 ] = {U}_{{I}_{1}} [ 14 ] [ 13 ] = {U}_{{I}_{1}} [ 18 ] [ 17 ] = {U}_{{I}_{1}} [ 22 ] [ 21 ] = \sqrt{1 / 2}$$

$${U}_{{I}_{1}} [ 3 ] [ 3 ] = {U}_{{I}_{1}} [ 7 ] [ 7 ] = {U}_{{I}_{1}} [ 11 ] [ 11 ] = {U}_{{I}_{1}} [ 15 ] [ 15 ] = {U}_{{I}_{1}} [ 19 ] [ 19 ] = {U}_{{I}_{1}} [ 23 ] [ 23 ] = 1$$

$${Λ}_{{I}_{2}} [ 0 ] [ 0 ] = {Λ}_{{I}_{2}} [ 2 ] [ 2 ] = {Λ}_{{I}_{2}} [ 12 ] [ 12 ] = {Λ}_{{I}_{2}} [ 14 ] [ 14 ] = 0.5 \qquad ( 19 )$$

$${Λ}_{{I}_{2}} [ 1 ] [ 1 ] = {Λ}_{{I}_{2}} [ 3 ] [ 3 ] = {Λ}_{{I}_{2}} [ 13 ] [ 13 ] = {Λ}_{{I}_{2}} [ 15 ] [ 15 ] = 0.5$$

$${Λ}_{{I}_{2}} [ 4 ] [ 4 ] = {Λ}_{{I}_{2}} [ 6 ] [ 6 ] = {Λ}_{{I}_{2}} [ 16 ] [ 16 ] = {Λ}_{{I}_{2}} [ 18 ] [ 18 ] = - 1$$

$${Λ}_{{I}_{2}} [ 5 ] [ 5 ] = {Λ}_{{I}_{2}} [ 7 ] [ 7 ] = {Λ}_{{I}_{2}} [ 17 ] [ 17 ] = {Λ}_{{I}_{2}} [ 19 ] [ 19 ] = 0.5$$

$${Λ}_{{I}_{2}} [ 8 ] [ 8 ] = {Λ}_{{I}_{2}} [ 10 ] [ 10 ] = {Λ}_{{I}_{2}} [ 20 ] [ 20 ] = {Λ}_{{I}_{2}} [ 22 ] [ 22 ] = - 1$$

$${Λ}_{{I}_{2}} [ 9 ] [ 9 ] = {Λ}_{{I}_{2}} [ 11 ] [ 11 ] = {Λ}_{{I}_{2}} [ 21 ] [ 21 ] = {Λ}_{{I}_{2}} [ 23 ] [ 23 ] = 0.5$$

$${U}_{{I}_{2}} [ 0 ] [ 0 ] = {U}_{{I}_{2}} [ 2 ] [ 2 ] = {U}_{{I}_{2}} [ 12 ] [ 12 ] = {U}_{{I}_{2}} [ 14 ] [ 14 ] = 1 \qquad ( 20 )$$

$${U}_{{I}_{2}} [ 1 ] [ 1 ] = {U}_{{I}_{2}} [ 3 ] [ 3 ] = {U}_{{I}_{2}} [ 13 ] [ 13 ] = {U}_{{I}_{2}} [ 15 ] [ 15 ] = \sqrt{1 / 3}$$

$${U}_{{I}_{2}} [ 4 ] [ 4 ] = {U}_{{I}_{2}} [ 6 ] [ 6 ] = {U}_{{I}_{2}} [ 16 ] [ 16 ] = {U}_{{I}_{2}} [ 18 ] [ 18 ] = \sqrt{1 / 3}$$

$${U}_{{I}_{2}} [ 1 ] [ 4 ] = {U}_{{I}_{2}} [ 3 ] [ 6 ] = {U}_{{I}_{2}} [ 13 ] [ 16 ] = {U}_{{I}_{2}} [ 15 ] [ 18 ] = \sqrt{2 / 3}$$

$${U}_{{I}_{2}} [ 4 ] [ 1 ] = {U}_{{I}_{2}} [ 6 ] [ 3 ] = {U}_{{I}_{2}} [ 16 ] [ 13 ] = {U}_{{I}_{2}} [ 18 ] [ 15 ] = \sqrt{2 / 3}$$

$${U}_{{I}_{2}} [ 5 ] [ 5 ] = {U}_{{I}_{2}} [ 7 ] [ 7 ] = {U}_{{I}_{2}} [ 17 ] [ 17 ] = {U}_{{I}_{2}} [ 19 ] [ 19 ] = \sqrt{2 / 3}$$

$${U}_{{I}_{2}} [ 8 ] [ 8 ] = {U}_{{I}_{2}} [ 10 ] [ 10 ] = {U}_{{I}_{2}} [ 20 ] [ 20 ] = {U}_{{I}_{2}} [ 22 ] [ 22 ] = \sqrt{2 / 3}$$

$${U}_{{I}_{2}} [ 5 ] [ 8 ] = {U}_{{I}_{2}} [ 7 ] [ 10 ] = {U}_{{I}_{2}} [ 17 ] [ 20 ] = {U}_{{I}_{2}} [ 19 ] [ 22 ] = \sqrt{1 / 3}$$

$${U}_{{I}_{2}} [ 8 ] [ 5 ] = {U}_{{I}_{2}} [ 10 ] [ 7 ] = {U}_{{I}_{2}} [ 20 ] [ 17 ] = {U}_{{I}_{2}} [ 22 ] [ 19 ] = \sqrt{1 / 3}$$

$${U}_{{I}_{2}} [ 9 ] [ 9 ] = {U}_{{I}_{2}} [ 11 ] [ 11 ] = {U}_{{I}_{2}} [ 21 ] [ 21 ] = {U}_{{I}_{2}} [ 23 ] [ 23 ] = 1$$

$${Λ}_{{I}_{3}} [ 0 ] [ 0 ] = {Λ}_{{I}_{3}} [ 2 ] [ 2 ] = {Λ}_{{I}_{3}} [ 4 ] [ 4 ] = {Λ}_{{I}_{3}} [ 6 ] [ 6 ] = {Λ}_{{I}_{3}} [ 8 ] [ 8 ] = {Λ}_{{I}_{3}} [ 10 ] [ 10 ] = 0.25 \qquad ( 21 )$$

$${Λ}_{{I}_{3}} [ 1 ] [ 1 ] = {Λ}_{{I}_{3}} [ 3 ] [ 3 ] = {Λ}_{{I}_{3}} [ 5 ] [ 5 ] = {Λ}_{{I}_{3}} [ 7 ] [ 7 ] = {Λ}_{{I}_{3}} [ 9 ] [ 9 ] = {Λ}_{{I}_{3}} [ 11 ] [ 11 ] = 0.25$$

$${Λ}_{{I}_{3}} [ 12 ] [ 12 ] = {Λ}_{{I}_{3}} [ 14 ] [ 14 ] = {Λ}_{{I}_{3}} [ 16 ] [ 16 ] = {Λ}_{{I}_{3}} [ 18 ] [ 18 ] = {Λ}_{{I}_{3}} [ 20 ] [ 20 ] = {Λ}_{{I}_{3}} [ 22 ] [ 22 ] = - 0.75$$

$${Λ}_{{I}_{3}} [ 13 ] [ 13 ] = {Λ}_{{I}_{3}} [ 15 ] [ 15 ] = {Λ}_{{I}_{3}} [ 17 ] [ 17 ] = {Λ}_{{I}_{3}} [ 19 ] [ 19 ] = {Λ}_{{I}_{3}} [ 21 ] [ 21 ] = {Λ}_{{I}_{3}} [ 23 ] [ 23 ] = 0.25$$

$${U}_{{I}_{3}} [ 0 ] [ 0 ] = {U}_{{I}_{3}} [ 2 ] [ 2 ] = {U}_{{I}_{3}} [ 4 ] [ 4 ] = {U}_{{I}_{3}} [ 6 ] [ 6 ] = {U}_{{I}_{3}} [ 8 ] [ 8 ] = {U}_{{I}_{3}} [ 10 ] [ 10 ] = 1 \qquad ( 22 )$$

$${U}_{{I}_{3}} [ 1 ] [ 1 ] = {U}_{{I}_{3}} [ 3 ] [ 3 ] = {U}_{{I}_{3}} [ 5 ] [ 5 ] = {U}_{{I}_{3}} [ 7 ] [ 7 ] = {U}_{{I}_{3}} [ 9 ] [ 9 ] = {U}_{{I}_{3}} [ 11 ] [ 11 ] = \sqrt{1 / 2}$$

$${U}_{{I}_{3}} [ 12 ] [ 12 ] = {U}_{{I}_{3}} [ 14 ] [ 14 ] = {U}_{{I}_{3}} [ 16 ] [ 16 ] = {U}_{{I}_{3}} [ 18 ] [ 18 ] = {U}_{{I}_{3}} [ 20 ] [ 20 ] = {U}_{{I}_{3}} [ 22 ] [ 22 ] = \sqrt{1 / 2}$$

$${U}_{{I}_{3}} [ 1 ] [ 12 ] = {U}_{{I}_{3}} [ 3 ] [ 14 ] = {U}_{{I}_{3}} [ 5 ] [ 16 ] = {U}_{{I}_{3}} [ 7 ] [ 18 ] = {U}_{{I}_{3}} [ 9 ] [ 20 ] = {U}_{{I}_{3}} [ 11 ] [ 22 ] = \sqrt{1 / 2}$$

$${U}_{{I}_{3}} [ 12 ] [ 1 ] = {U}_{{I}_{3}} [ 14 ] [ 3 ] = {U}_{{I}_{3}} [ 16 ] [ 5 ] = {U}_{{I}_{3}} [ 18 ] [ 7 ] = {U}_{{I}_{3}} [ 20 ] [ 9 ] = {U}_{{I}_{3}} [ 22 ] [ 11 ] = \sqrt{1 / 2}$$

$${U}_{{I}_{3}} [ 13 ] [ 13 ] = {U}_{{I}_{3}} [ 15 ] [ 15 ] = {U}_{{I}_{3}} [ 17 ] [ 17 ] = {U}_{{I}_{3}} [ 19 ] [ 19 ] = {U}_{{I}_{3}} [ 21 ] [ 21 ] = {U}_{{I}_{3}} [ 23 ] [ 23 ] = 1$$

For each partition Pᵢ, the following Hamiltonian matrices are obtained, as illustrated at Equations 23 to 26. Because of equal g-factors, the Hamiltonian circuit splitting explained can be employed relative to FIG. 14, above.

### Equations 23 to 26:

$${H}_{hfc , {P}_{1}} = {\sum }_{k = 1}^{3} {a}_{k} \times {U}_{{I}_{k} , {P}_{1}} {Λ}_{{I}_{k} , {P}_{1}} {U}_{{I}_{k} , {P}_{1}} , ∀ i = 1 , 2 , 3 , 4 \qquad ( 23 )$$

$${H}_{{B}_{1} , {P}_{1}} = - {b}_{1} {1}_{24} ⊗ Z , {H}_{{B}_{1} , {P}_{2}} = - {b}_{1} {1}_{8} ⊗ Z , {H}_{{B}_{1} , {P}_{3}} = - {b}_{1} {1}_{12} ⊗ Z , {H}_{{B}_{1} , {P}_{4}} = - {b}_{1} {1}_{4} ⊗ Z \qquad ( 24 )$$

$${H}_{{P}_{1}}^{+} = [ ( {H}_{hfc , {P}_{1}} ⊕ {0}_{16} ) + {H}_{{B}_{1} , {P}_{1}} ] , {H}_{{P}_{2}}^{+} = [ ( {H}_{hfc , {P}_{2}} + {H}_{{B}_{1} , {P}_{2}} ) ] \qquad ( 25 )$$

$${H}_{{P}_{3}}^{+} = [ ( {H}_{hfc , {P}_{3}} ⊕ {0}_{8} ) + {H}_{{B}_{1} , {P}_{3}} ] , {H}_{{P}_{4}}^{+} = [ ( {H}_{hfc , {P}_{4}} + {H}_{{B}_{1} , {P}_{4}} ) ]$$

$${H}_{{P}_{1}}^{-} = - {b}_{2} Z , ∀ i = 1 , 2 , 3 , 4 \qquad ( 26 )$$

Accordingly, Hₚ⁺, Hₚ⁻ can be run on the circuit illustrated at FIG. 14 and obtain curves S_{Pi}(t), which can be later combined in a final classical post-processing step, e.g., employing the analysis component 318, as explained below.

Operation of the Quantum Circuit: As explained above and illustrated relative to FIG. 3, instructions from the quantum circuit generation component 314 can be transmitted to the quantum operation component 103 as one or more quantum job requests 124. Based on the one or more quantum job requests 124, the quantum operation component 103 can direct execution of the quantum circuit, in one or more partitioned shots, using the quantum processor 106 and waveform generator 110. The quantum readout electronics 112 can output one or more quantum measurement readouts 120 for use in classical post-processing by the analysis component 318, such as to combine (e.g., aggregate) the results from a quantum circuit operated as more than one shot due to partitioning performed by the partitioning component 316.

Classical Post-Processing: The analysis component 318 can be employed to post-process the singlet state probability curves from each mixed-state simulation of a given Hamiltonian partition, generated based on the quantum measurement readouts 120. As previously, this post-processing is described herein for partitioning method [1] from Table 800 since others can be derived analogously.

For a Hamiltonian partition parametrized with fixed nuclear total spin numbers {I_{K}, I_{K-1}, . . . , I₁}, the mixed state simulation circuit outputs the probability curve S_{IKIK-1} . . . I₁(t). To recover the correct overall S(t), a number of aspects are first defined, e.g., by the analysis component 318.

The total number of basis states in the Hamiltonian partition {I_{K}, I_{K-1}, . . . , I₁} is represented by Equation 27.

$$b = {\prod }_{k = 1}^{K} ( 2 {I}_{k} + 1 ) = {\prod }_{k = 1}^{K} {n}_{{I}_{k}} . \qquad Equation 27$$

The number of qubits required for the nuclear subsystem of the radical cation is represented by Equation 28.

$$Q = ⌈ {log}_{2} b ⌉ = ⌈ {\sum }_{k = 1}^{K} {log}_{2} {n}_{{I}_{k}} ⌉ . \qquad Equation 28$$

Accordingly, the size of the Hamiltonian matrix H⁺ acting on both the nuclear and the electronic degrees of the radical cation is represented by Equation 29.

$$s = {2}^{Q + 1} = 2 ⌈ {\sum }_{k = 1}^{K} {log}_{2} {n}_{{I}_{k}} ⌉ + 1. \qquad Equation 29$$

Recall that if needed, zeros are inserted into the matrix to ensure that H size is a power of 2. The number of appended zeros in the diagonal of H as represented at Equation 16 is represented by Equation 30.

$$z = s - 2 b = 2 ( {2}^{⌈ {\sum }_{k = 1}^{K} {log}_{2} {n}_{{I}_{k}} ⌉} - {\prod }_{k = 1}^{K} {n}_{{I}_{k}} ) . \qquad Equation 30$$

Where a maximally mixed state is initiated on the nuclear qubits and the singlet state on the electronic qubits, the appended zeros in the Hamiltonian that correspond to an identity evolution simply introduce weighted z/2 probability ones into the measurement output (division by 2 is to eliminate the electronic degree). These can be equally mixed with the pure state outputs included in the Hamiltonian basis partition. As such, each Hamiltonian partition simulation outputs Equation 31.

$${S}_{{I}_{K} {I}_{K - 1} {…I}_{1}} ( t ) = \frac{{\sum }_{{m}_{{I}_{K}} , {m}_{{I}_{K - 1}} , {…m}_{{I}_{1}}} S ( \vert {I}_{K} , {m}_{{I}_{k}} 〉 … \vert {I}_{1} , {m}_{{I}_{1}} 〉 )}{{2}^{Q}} + \frac{1 \times z / 2}{{2}^{Q}} \qquad Equation 31$$

At Equation 31, S(|I_{K}, m_{Ik} [symbol] . . . |I₁, m_{I1} [symbol] ) denotes the singlet state probability curve that would be obtained were the simulation run on the pure nuclear initial state |I_{K}, m_{Ik} [symbol] . . . |I₁, m_{I1} [symbol] . As such, a goal is to build an equally weighted average of all nuclear basis states including the degeneracies.

For this, S_{IKIK-1} . . . I₁(t) is measured using the circuit at FIG. 14 for all {I_{K}, I_{K-1}, . . . , I₁} partitions, and recover each Σ_{mIk, mIK-1, . . . , mI1} S(|I_{K}, m_{Ik}) . . . |I₁, m_{I1} [symbol] ) using Equation 31. Note that each of these sums in fact occurs with degeneracy Πₖ₌₁^{K}d_{Ik}, where di are defined in Equation 5. Finally, an equally weighted average of all probabilities can be constructed, e.g., by the analysis component 318, using these degeneracy counts as follows, to replicate the maximally mixed nuclear initial state ½^{N}. See, Equation 32, below.

$$S ( t ) = \frac{{\sum }_{{I}_{K} {I}_{K - 1} … {I}_{1}} ( {\sum }_{{m}_{{I}_{K}} , {m}_{{I}_{K - 1}} , … {m}_{{I}_{1}}} S ( \vert {I}_{K} , {m}_{{I}_{k}} 〉 … \vert {I}_{1} , {m}_{{I}_{1}} 〉 ) \times {\prod }_{k = 1}^{K} {d}_{{I}_{k}} )}{{2}^{N}} . \qquad Equation 32$$

For other Hamiltonian partitioning strategies, the degeneracy counts should be adjusted accordingly. Indeed, all multiplicities should be accounted for in the basis state list when an entire set of states corresponding to a specific Iₖ are included in the Hamiltonian partition. This can be precisely because access can be lost to the corresponding d_{Ik} in Equation 32. In other words, if states are not included with the d_{Ik} multiplicities in alternative partitioning strategies, initial nuclear states would mix with incorrect weights in the mixed state circuit, and the overall S(t) would be unable to recovered.

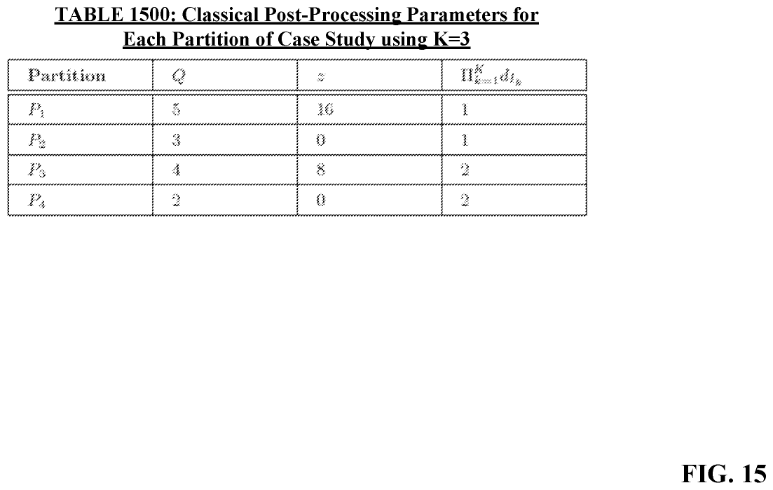

Example Post-Processing Case with K=3: Extending from the example case study discussed above using K=3, the required parameters for the final classical post-processing of the S_{Pi}(t) curves from each partition are illustrated in Table 1500 of FIG. 15.

The overall singlet state probability curve is represented by Equation 33.

$$S ( t ) = \frac{{\sum }_{i = 1}^{4} ( {S}_{{P}_{1}} ( t ) \times {2}^{{Q}_{{P}_{1}}} - {z}_{{P}_{1}} / 2 ) \times {\prod }_{k = 1}^{K} {d}_{{I}_{k}} , {P}_{1}}{{2}^{N}} . \qquad Equation 33$$

### Interim Summary

The above-described takes as input an arbitrary number of HFC constants aₖ, their corresponding spin-1/2 nuclei counts nₖ, the unidirectional magnetic field strength B, and two g-factors. It outputs the coherent singlet state measurement probability S(t). The method also can deliver the first method in the literature that can calculate the exact S(t) curve for arbitrary finite magnetic fields, for arbitrary sized problems.

It is noted that while setting up the procedure for operation at the quantum system 101, additional considerations can comprise constraints in near-term quantum hardware by taking required qubit and simulation costs into account. That is, all U_{Ik} in H_{hfc,k} are scattered copies of Iₖ⊕½ Clebsch-Gordan matrices, and therefore have at most 2 nonzero entries in any row and column of U_{Ik} in H_{hfc,k}. This can guarantee the existence of an efficient circuit decomposition for each Uₖ. It is also noted that in general there is a one time procedure of size 2N to employ for setting up and compiling the unitary corresponding to the Hamiltonian into one and two-qubit gate sequences, when making use of generic unitary decomposition methods that are not tailored to the specific types of unitaries described above.

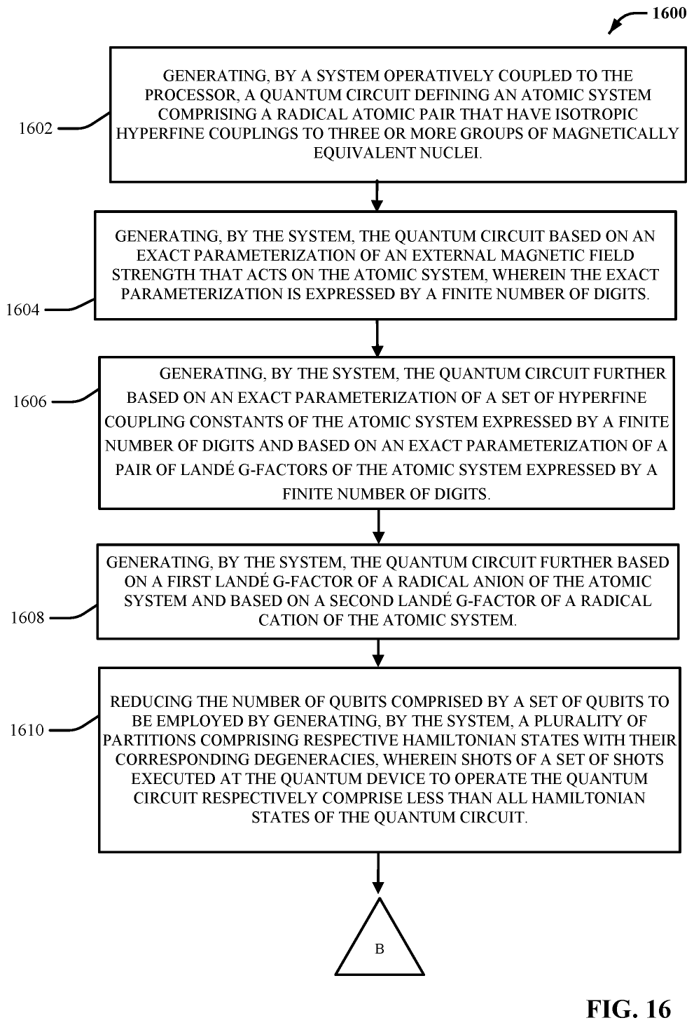

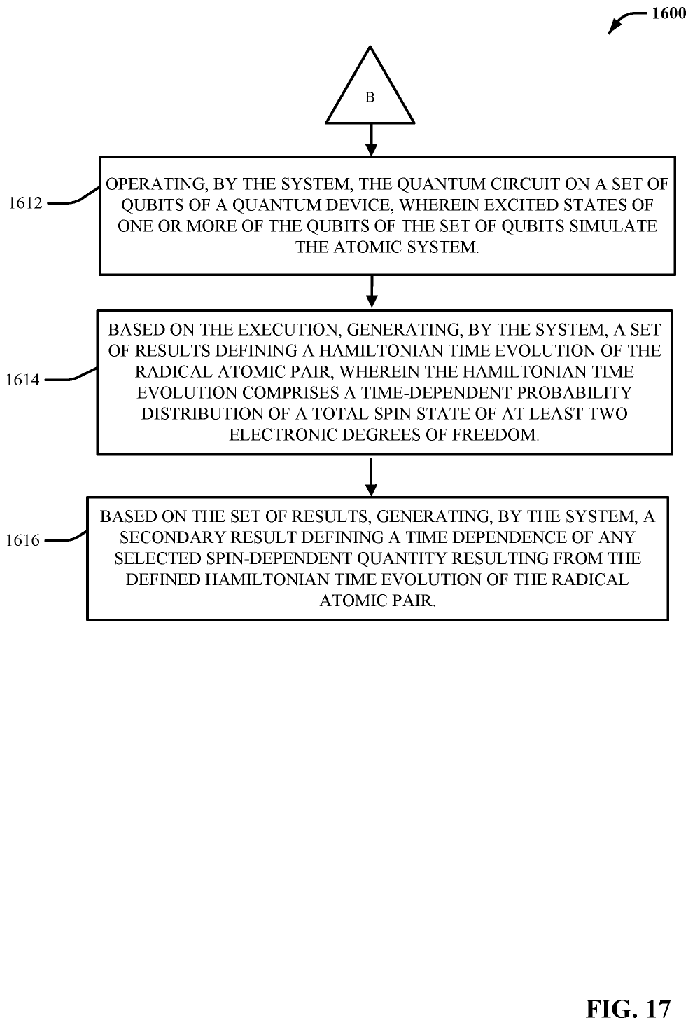

Next. FIGS. 16 and 17 illustrate a flow diagram of an example, non-limiting method 1600 that can provide a process to determine spin behavior of an atomic system, in accordance with one or more embodiments described herein, such as the non-limiting system 300 of FIG. 3. While the non-limiting method 1600 is described relative to the non-limiting system 300 of FIG. 3, the non-limiting method 1600 can be applicable also to other systems described herein, such as the non-limiting system 100 of FIG. 1 or non-limiting system 200 of FIG. 2. Repetitive description of like elements and/or processes employed in respective embodiments is omitted for sake of brevity.

At 1602, the non-limiting method 1600 can comprise generating, e.g., by a system operatively coupled to a processor (e.g., quantum circuit generation component 314 of a classical portion 302 of a hybrid classical-quantum system 300), a quantum circuit defining an atomic system comprising a radical atomic pair that have isotropic hyperfine couplings to three or more groups of magnetically equivalent nuclei.

At 1604, the non-limiting method 1600 can comprise, generating, by the system (e.g., quantum circuit generation component 314), the quantum circuit based on an exact parameterization of an external magnetic field strength that acts on the atomic system, wherein the exact parameterization is expressed by a finite number of digits.

At 1606, the non-limiting method 1600 can comprise, generating, by the system (e.g., quantum circuit generation component 314), the quantum circuit further based on an exact parameterization of a set of hyperfine coupling constants of the atomic system expressed by a finite number of digits and based on an exact parameterization of a pair of Landé g-factors of the atomic system expressed by a finite number of digits.

At 1608, the non-limiting method 1600 can comprise, generating, by the system (e.g., quantum circuit generation component 314), the quantum circuit further based on a first Landé g-factor of a radical anion of the atomic system and based on a second Landé g-factor of a radical cation of the atomic system.

At 1610, the non-limiting method 1600 can comprise, reducing the number of qubits comprised by the set of qubits to be employed by generating, by the system (e.g., partitioning component 316 of the classical portion 302 of the hybrid classical-quantum system 300) a plurality of partitions comprising respective Hamiltonian states with their corresponding degeneracies, wherein shots of a set of shots executed at the quantum device (e.g., quantum system 101) to operate the quantum circuit respectively comprise less than all Hamiltonian states of the quantum circuit.

At 1612, the non-limiting method 1600 can comprise operating, by the system (e.g., quantum operation component 103 of a quantum portion 101 of a hybrid classical-quantum system 300) the quantum circuit on a set of qubits of a quantum device (e.g., quantum system 101), wherein excited states of one or more of the qubits of the set of qubits simulate the atomic system.

At 1614, the non-limiting method 1600 can comprise, based on the execution, generating, by the system (e.g., analysis component 318 of the classical portion 302 of the hybrid classical-quantum system 300) a set of results defining a Hamiltonian time evolution of the radical atomic pair, wherein the Hamiltonian time evolution comprises a time-dependent probability distribution of a total spin state of at least two electronic degrees of freedom.

At 1616, the non-limiting method 1600 can comprise, based on the set of results, generating, by the system (e.g., analysis component 318 of the classical portion 302 of the hybrid classical-quantum system 300) a secondary result defining a time dependence of any selected spin-dependent quantity resulting from the defined Hamiltonian time evolution of the radical atomic pair.

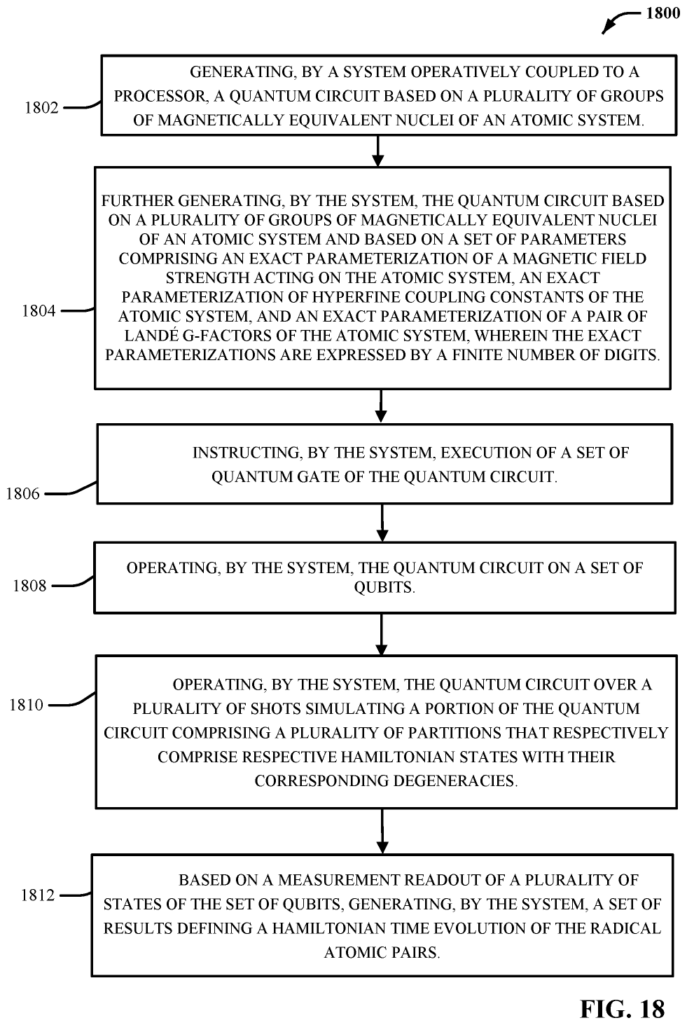

Next, in additional summary, FIG. 18 illustrates a flow diagram of an example, non-limiting method 1800 that can provide another process to determine spin behavior of an atomic system, in accordance with one or more embodiments described herein, such as the non-limiting system 300 of FIG. 3. While the non-limiting method 1800 is described relative to the non-limiting system 300 of FIG. 3, the non-limiting method 1800 can be applicable also to other systems described herein, such as the non-limiting system 100 of FIG. 1 or non-limiting system 200 of FIG. 2. Repetitive description of like elements and/or processes employed in respective embodiments is omitted for sake of brevity.

At 1802, the non-limiting method 1800 can comprise generating, by a system operatively coupled to a processor (e.g., quantum circuit generation component 314 of a classical portion 302 of a hybrid classical-quantum system 300), a quantum circuit based on a plurality of groups of magnetically equivalent nuclei of an atomic system.

At 1804, the non-limiting method 1800 can comprise generating, by the system (e.g., quantum circuit generation component 314), the quantum circuit based on a set of parameters comprising an exact parameterization of a magnetic field strength acting on the atomic system, an exact parameterization of hyperfine coupling constants of the atomic system, and an exact parameterization of a pair of Landé g-factors of the atomic system, wherein the exact parameterizations are expressed by a finite number of digits.

At 1804, the non-limiting method 1800 can comprise instructing, by the system (e.g., quantum circuit generation component 314), execution of a quantum gate of the quantum circuit.

At 1806, the non-limiting method 1800 can comprise operating, by the system (e.g., quantum operation component 103 of a quantum portion 101 of a hybrid classical-quantum system 300) the quantum circuit on a set of qubits (e.g., of quantum system 101).

At 1808, the non-limiting method 1800 can comprise operating, by the system (e.g., quantum operation component 103) the quantum circuit over a plurality of shots simulating a portion of the quantum circuit comprising a plurality of partitions that respectively comprise respective Hamiltonian states with their corresponding degeneracies.

At 1810, the non-limiting method 1800 can comprise based on a measurement readout of a plurality of states of the set of qubits, generating, by the system (e.g., analysis component 318 of the classical portion 302 of the hybrid classical-quantum system 300) a set of results defining a Hamiltonian time evolution of the radical atomic pairs.

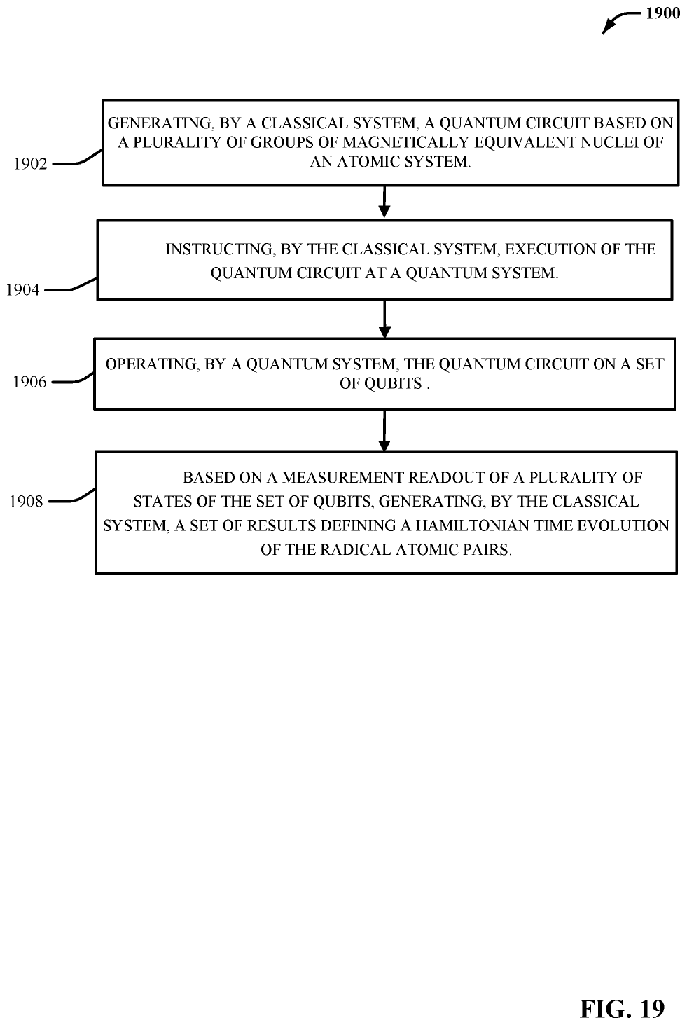

Next, in further summary, FIG. 19 illustrates a flow diagram of an example, non-limiting method 1900 that can provide still another process to determine spin behavior of an atomic system, in accordance with one or more embodiments described herein, such as the non-limiting system 300 of FIG. 3. While the non-limiting method 1900 is described relative to the non-limiting system 300 of FIG. 3, the non-limiting method 1900 can be applicable also to other systems described herein, such as the non-limiting system 100 of FIG. 1 or non-limiting system 200 of FIG. 2. Repetitive description of like elements and/or processes employed in respective embodiments is omitted for sake of brevity.

At 1902, the non-limiting method 1900 can comprise generating, by a classical system operatively coupled to a processor (e.g., quantum circuit generation component 314 of a classical portion 302 of a hybrid classical-quantum system 300), a quantum circuit based on a plurality of groups of magnetically equivalent nuclei of an atomic system.

At 1904, the non-limiting method 1900 can comprise instructing, by the classical system (e.g., quantum circuit generation component 314), execution of the quantum circuit at a quantum device (e.g., quantum system 101 of the hybrid classical-quantum system 300).

At 1906, the non-limiting method 1900 can comprise operating, by a quantum system (e.g., quantum operation component 103 of a quantum portion 101 of a hybrid classical-quantum system 300) the quantum circuit on a set of qubits (e.g., of quantum system 101).

At 1908, the non-limiting method 1900 can comprise based on a measurement readout of a plurality of states of the set of qubits, generating, by the classical system (e.g., analysis component 318 of the classical portion 302 of the hybrid classical-quantum system 300) a set of results defining a Hamiltonian time evolution of the radical atomic pairs.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

Where description indicates a process as taking place at a classical system or a quantum system, it is noted that in one or more other embodiments, such process can take place, at least partially, at the other of the classical system or the quantum system, where suitable and/or where such other system is configured to perform the process.

In summary, one or more or more systems, devices, computer program products and/or computer-implemented methods of use provided herein relate to a process to determine spin behavior of magnetically equivalent nuclei. An example system comprises a memory that stores computer executable components; and a processor that executes the computer executable components stored in the memory, wherein the computer executable components comprise a quantum circuit generation component that generates a quantum circuit defining an atomic system comprising a radical atomic pair that have isotropic hyperfine couplings to three or more groups of magnetically equivalent nuclei; and a quantum operation component that operates the quantum circuit on a set of qubits of a quantum device, wherein excited states of one or more of the qubits of the set of qubits simulate the atomic system.

An advantage of any one or more of the above-indicated embodiments can be an ability to determine, by simulation, spin behavior of a set of radical pairs with isotropic hyperfine couplings to 3 or more groups of magnetically equivalent nuclei of an atomic system comprising the set of radical pairs. As compared to existing approaches only allowing for such simulation relative to a set of radical pairs with isotropic hyperfine couplings to at most two groups of magnetically equivalent nuclei. That is, for systems having three or more sets of hyperfine coupling constants, classical approaches fail to provide an analytic solution.

Another advantage of the above-indicated embodiments can be use of exact parameterization, in place of approximations used in existing approached, for a magnetic field strength affecting the sets of radical pairs, for the set of hyperfine coupling constants and/or for a pair of Landé g-factors of the atomic system.

In one or more embodiments of the above-indicated systems, computer-implemented method and/or computer program product, a partitioning component reduces the number of qubits comprised by the set of qubits to be employed by generating a plurality of partitions each comprising respective Hamiltonian states with their corresponding degeneracies, wherein each shot a set of shots executed at the quantum device to operate the quantum circuit comprises less than all Hamiltonian states of the quantum circuit.

An advantage thereof can be alignment of the quantum circuit relative to a mapping of the qubits of a quantum device on which the quantum circuit is to be operated. That is, where operating the full quantum circuit in a single shot may employ x qubits, partitioning of the quantum circuit into respective partitions can allow for <x qubits to be employed to operate each of a plurality of shots, where each shot of the plurality of shots comprises one or more partitions.

Indeed, in view of the one or more embodiments described herein, a practical application of the systems, computer-implemented methods and/or computer program products described herein can be ability to accurately simulate, using exact parameterization of a quantum circuit and operation of a plurality of qubits, the spin behavior of one or more radical atomic pairs of an atomic system, where the radical atomic pairs have isotropic hyperfine couplings to a plurality of magnetically equivalent nuclei of the atomic system.

Further, another practical application of the systems, computer-implemented methods and/or computer program products described herein can be an ability to partition the Hamiltonian states of such a simulation, and thus partition the quantum circuit, for an atomic system with any arbitrary number of hyperfine coupling constants (corresponding to a same arbitrary number of magnetically equivalent nuclei of the atomic system). That is, the partitioning can allow for alignment of operation of the quantum circuit with execution on an available qubit mapping. The quantum circuit can be partitioned into a set of shots, where each shot can be aligned to the available qubit mapping. As a trade-off, an increased number of shots can correspond to an increased amount of classical computation using the measurement readout results of the quantum system to thereby aggregate the measurement readout results for the total quantum circuit.

That is, when operating a hybrid classical-quantum hybrid system, the one or more embodiments provided herein improve functioning of the hybrid system. Improvement can be by way of allowing for analysis of spin behavior of an atomic system comprising a plurality of magnetically equivalent nuclei using the quantum portion of the hybrid system, thus allowing for analysis not a number of magnetically equivalent nuclei not available through use of a classical system alone. Furthermore, improvement can be by way of using exact parameterization for an external magnetic field strength, hyperfine coupling constants corresponding to the groups of magnetically equivalent nuclei, and/or Landé g-factors of the radical atomic pairs, which can allow for more efficient and more rapid analysis than by use of a classical system alone and/or by way of existing frameworks.

Furthermore, one or more embodiments described herein can be employed in a real-world system based on the disclosed teachings. For example, one or more embodiments described herein can function with a quantum system that can receive as input a quantum job request comprising a quantum source code for execution comprising one or more operations as described herein, and that can measure a real-world qubit state of one or more qubits, such as superconducting qubits, of the quantum system, by executing the quantum source code at some level of the quantum system.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to quantum-based analysis of spin behavior of radical pair systems, as compared to existing systems and/or techniques. Systems, computer-implemented methods and/or computer program products providing performance of these processes are of great utility in the fields of quantum circuit operation and/or spin behavior analysis including analysis of recombination fluorescence intensity, and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically perform quantum circuit encoding, load a quantum register, perform quantum calculations, generate a waveform and/or measure a state of qubit as the one or more embodiments described herein can provide these processes. Moreover, neither can the human mind nor a human with pen and paper conduct one or more of these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical-quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

### Computing Environment Description

Turning next to FIG. 20, a detailed description is provided of additional context for the one or more embodiments described herein at FIGS. 1-19.

FIG. 20 and the following discussion are intended to provide a brief, general description of a suitable computing environment 2000 in which one or more embodiments described herein at FIGS. 1-19 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 2000 contains an example of an environment for the execution of at least some of the computer code involved in performing the inventive methods, such as translation of an original source code based on a configuration of a target system by the quantum operation execution code 2080. In addition to block 2080, computing environment 2000 includes, for example, computer 2001, wide area network (WAN) 2002, end user device (EUD) 2003, remote server 2004, public cloud 2005, and private cloud 2006. In this embodiment, computer 2001 includes processor set 2010 (including processing circuitry 2020 and cache 2021), communication fabric 2011, volatile memory 2012, persistent storage 2013 (including operating system 2022 and block 2080, as identified above), peripheral device set 2014 (including user interface (UI), device set 2023, storage 2024, and Internet of Things (IoT) sensor set 2025), and network module 2015. Remote server 2004 includes remote database 2030. Public cloud 2005 includes gateway 2040, cloud orchestration module 2041, host physical machine set 2042, virtual machine set 2043, and container set 2044.

COMPUTER 2001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 2030. As is well understood in the art of computer technology, and depending upon the technology, performance of a computer-implemented method may be distributed among multiple computers and/or between multiple locations. On the other hand, in this presentation of computing environment 2000, detailed discussion is focused on a single computer, specifically computer 2001, to keep the presentation as simple as possible. Computer 2001 may be located in a cloud, even though it is not shown in a cloud in FIG. 20. On the other hand, computer 2001 is not required to be in a cloud except to any extent as may be affirmatively indicated.

PROCESSOR SET 2010 includes one, or more, computer processors of any type now known or to be developed in the future. Processing circuitry 2020 may be distributed over multiple packages, for example, multiple, coordinated integrated circuit chips. Processing circuitry 2020 may implement multiple processor threads and/or multiple processor cores. Cache 2021 is memory that is located in the processor chip package(s) and is typically used for data or code that should be available for rapid access by the threads or cores running on processor set 2010. Cache memories are typically organized into multiple levels depending upon relative proximity to the processing circuitry. Alternatively, some, or all, of the cache for the processor set may be located “off chip.” In some computing environments, processor set 2010 may be designed for working with qubits and performing quantum computing.

Computer readable program instructions are typically loaded onto computer 2001 to cause a series of operational steps to be performed by processor set 2010 of computer 2001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 2021 and the other storage media discussed below. The program instructions, and associated data, are accessed by processor set 2010 to control and direct performance of the inventive methods. In computing environment 2000, at least some of the instructions for performing the inventive methods may be stored in block 2080 in persistent storage 2013.

COMMUNICATION FABRIC 2011 is the signal conduction paths that allows the various components of computer 2001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 2012 is any type of volatile memory now known or to be developed in the future. Examples include dynamic type random access memory (RAM) or static type RAM. Typically, the volatile memory is characterized by random access, but this is not required unless affirmatively indicated. In computer 2001, the volatile memory 2012 is located in a single package and is internal to computer 2001, but, alternatively or additionally, the volatile memory may be distributed over multiple packages and/or located externally with respect to computer 2001.

PERSISTENT STORAGE 2013 is any form of non-volatile storage for computers that is now known or to be developed in the future. The non-volatility of this storage means that the stored data is maintained regardless of whether power is being supplied to computer 2001 and/or directly to persistent storage 2013. Persistent storage 2013 may be a read only memory (ROM), but typically at least a portion of the persistent storage allows writing of data, deletion of data and re-writing of data. Some familiar forms of persistent storage include magnetic disks and solid state storage devices. Operating system 2022 may take several forms, such as various known proprietary operating systems or open source Portable Operating System Interface type operating systems that employ a kernel. The code included in block 2080 typically includes at least some of the computer code involved in performing the inventive methods.

PERIPHERAL DEVICE SET 2014 includes the set of peripheral devices of computer 2001. Data communication connections between the peripheral devices and the other components of computer 2001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 2023 may include components such as a display screen, speaker, microphone, wearable devices (such as goggles and smart watches), keyboard, mouse, printer, touchpad, game controllers, and haptic devices. Storage 2024 is external storage, such as an external hard drive, or insertable storage, such as an SD card. Storage 2024 may be persistent and/or volatile. In some embodiments, storage 2024 may take the form of a quantum computing storage device for storing data in the form of qubits. In embodiments where computer 2001 is required to have a large amount of storage (for example, where computer 2001 locally stores and manages a large database) then this storage may be provided by peripheral storage devices designed for storing very large amounts of data, such as a storage area network (SAN) that is shared by multiple, geographically distributed computers. IoT sensor set 2025 is made up of sensors that can be used in Internet of Things applications. For example, one sensor may be a thermometer and another sensor may be a motion detector.

NETWORK MODULE 2015 is the collection of computer software, hardware, and firmware that allows computer 2001 to communicate with other computers through WAN 2002. Network module 2015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 2015 are performed on the same physical hardware device. In other embodiments (for example, embodiments that utilize software-defined networking (SDN)), the control functions and the forwarding functions of network module 2015 are performed on physically separate devices, such that the control functions manage several different network hardware devices. Computer readable program instructions for performing the inventive methods can typically be downloaded to computer 2001 from an external computer or external storage device through a network adapter card or network interface included in network module 2015.

WAN 2002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 2003 is any computer system that is used and controlled by an end user (for example, a customer of an enterprise that operates computer 2001) and may take any of the forms discussed above in connection with computer 2001. EUD 2003 typically receives helpful and useful data from the operations of computer 2001. For example, in a hypothetical case where computer 2001 is designed to provide a recommendation to an end user, this recommendation would typically be communicated from network module 2015 of computer 2001 through WAN 2002 to EUD 2003. In this way, EUD 2003 can display, or otherwise present, the recommendation to an end user. In some embodiments, EUD 2003 may be a client device, such as thin client, heavy client, mainframe computer, desktop computer and so on.

REMOTE SERVER 2004 is any computer system that serves at least some data and/or functionality to computer 2001. Remote server 2004 may be controlled and used by the same entity that operates computer 2001. Remote server 2004 represents the machine(s) that collect and store helpful and useful data for use by other computers, such as computer 2001. For example, in a hypothetical case where computer 2001 is designed and programmed to provide a recommendation based on historical data, then this historical data may be provided to computer 2001 from remote database 2030 of remote server 2004.

PUBLIC CLOUD 2005 is any computer system available for use by multiple entities that provides on-demand availability of computer system resources and/or other computer capabilities, especially data storage (cloud storage) and computing power, without direct active management by the scale. The direct and active management of the computing resources of public cloud 2005 is performed by the computer hardware and/or software of cloud orchestration module 2041. The computing resources provided by public cloud 2005 are typically implemented by virtual computing environments that run on various computers making up the computers of host physical machine set 2042, which is the universe of physical computers in and/or available to public cloud 2005. The virtual computing environments (VCEs) typically take the form of virtual machines from virtual machine set 2043 and/or containers from container set 2044. It is understood that these VCEs may be stored as images and may be transferred among and between the various physical machine hosts, either as images or after instantiation of the VCE. Cloud orchestration module 2041 manages the transfer and storage of images, deploys new instantiations of VCEs and manages active instantiations of VCE deployments. Gateway 2040 is the collection of computer software, hardware, and firmware that allows public cloud 2005 to communicate through WAN 2002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 2006 is similar to public cloud 2005, except that the computing resources are only available for use by a single enterprise. While private cloud 2006 is depicted as being in communication with WAN 2002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 2005 and private cloud 2006 are both part of a larger hybrid cloud.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures and/or the like that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “example” are utilized to mean serving as an example, instance, or illustration. For the avoidance of doubt, the subject matter described herein is not limited by such examples. In addition, any aspect or design described herein as an “example” and/or “example” is not necessarily to be construed as preferred or advantageous over other aspects or designs, nor is it meant to preclude equivalent example structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a quantum circuit generation component that generates a quantum circuit defining an atomic system comprising a radical atomic pair that have isotropic hyperfine couplings to three or more groups of magnetically equivalent nuclei; and
a quantum operation component that operates the quantum circuit on a set of qubits of a quantum device, wherein excited states of one or more of the qubits of the set of qubits simulate the atomic system.

2. The system of claim 1, wherein the quantum circuit generation component generates the quantum circuit based on an exact parameterization of an external magnetic field strength that acts on the atomic system, wherein the exact parameterization is expressed by a finite number of digits.

3. The system of claim 2, wherein the quantum circuit generation component further generates the quantum circuit based on an exact parameterization of a set of hyperfine coupling constants of the atomic system expressed by a finite number of digits and based on an exact parameterization of a pair of Landé g-factors of the atomic system expressed by a finite number of digits.

4. The system of claim 1, wherein the quantum circuit generation component further generates the quantum circuit further based on a first Landé g-factor of a radical anion of the atomic system and based on a second Landé g-factor of a radical cation of the atomic system.

5. The system of claim 1, wherein the computer executable components further comprise:
an analysis component that generates a set of results defining a Hamiltonian time evolution of the radical atomic pair, wherein the Hamiltonian time evolution comprises a time-dependent probability distribution of a total spin state of at least two electronic degrees of freedom.

6. The system of claim 5, wherein the analysis component further generates a secondary result defining a time dependence of any selected spin-dependent quantity resulting from the defined Hamiltonian time evolution of the radical atomic pair.

7. The system of claim 1, wherein the computer executable components further comprise:
a partitioning component that reduces a number of qubits of the set of qubits to be employed by generating a plurality of partitions comprising respective Hamiltonian states with their corresponding degeneracies, wherein shots of a set of shots executed at the quantum device to operate the quantum circuit respectively comprise less than all Hamiltonian states of the quantum circuit.

8. A computer-implemented method, comprising:
generating, by a system operatively coupled to at least one processor, a quantum circuit defining an atomic system comprising a radical atomic pair that have isotropic hyperfine couplings to three or more groups of magnetically equivalent nuclei; and
operating, by the system, the quantum circuit on a set of qubits of a quantum device, wherein excited states of one or more of the qubits of the set of qubits simulate the atomic system.

9. The computer-implemented method of claim 8, wherein the generating the quantum circuit is based on an exact parameterization of an external magnetic field strength that acts on the atomic system, wherein the exact parameterization is expressed by a finite number of digits.

10. The computer-implemented method of claim 9, wherein the generating the quantum circuit is further based on an exact parameterization of a set of hyperfine coupling constants of the atomic system expressed by a finite number of digits and based on an exact parameterization of a pair of Landé g-factors of the atomic system expressed by a finite number of digits.

11. The computer-implemented method of claim 8, wherein the generating the quantum circuit is further based on a first Landé g-factor of a radical anion of the atomic system and based on a second Landé g-factor of a radical cation of the atomic system.

12. The computer-implemented method of claim 8, further comprising:
generating, by the system, a set of results defining a Hamiltonian time evolution of the radical atomic pair, comprising a time-dependent probability distribution of a total spin state of at least two electronic degrees of freedom.

13. The computer-implemented method of claim 12, further comprising:
generating, by the system, a secondary result defining a time dependence of any selected spin-dependent quantity resulting from the defined Hamiltonian time evolution of the radical atomic pair.

14. The computer-implemented method of claim 8, further comprising:
generating, by the system, a plurality of partitions comprising respective Hamiltonian states with their corresponding degeneracies, wherein shots of a set of shots executed at the quantum device to operate the quantum circuit respectively comprise less than all Hamiltonian states of the quantum circuit, and wherein the generating reduces the number of qubits comprised by the set of qubits.

15. A computer program product facilitating a process for determination of spin behavior of magnetically equivalent nuclei, the computer program product comprising a computer readable storage medium having program instructions embodied therewith, the program instructions executable by a processor to cause the processor to:
generate, by the processor, a quantum circuit defining an atomic system comprising a radical atomic pair that have isotropic hyperfine couplings to three or more groups of magnetically equivalent nuclei; and
operate, by a quantum processor communicatively coupled to the processor, the quantum circuit on a set of qubits of a quantum device, wherein excited states of one or more of the qubits of the set of qubits simulate the atomic system.

16. The computer program product of claim 15, wherein the generation of the quantum circuit is based on an exact parameterization of an external magnetic field strength that acts on the atomic system, wherein the exact parameterization is expressed by a finite number of digits.

17. The computer program product of claim 16, wherein the generation of the quantum circuit is further based on an exact parameterization of a set of hyperfine coupling constants of the atomic system expressed by a finite number of digits and based on an exact parameterization of a pair of Landé g-factors of the atomic system expressed by a finite number of digits.

18. The computer program product of claim 15, wherein the generation of the quantum circuit is further based on a first Landé g-factor of a radical anion of the atomic system and based on a second Landé g-factor of a radical cation of the atomic system.

19. The computer program product of claim 15, wherein the program instructions are executable by the processor to further cause the processor to:
generate, by the processor, a set of results defining a Hamiltonian time evolution of the radical atomic pair, comprising a time-dependent probability distribution of a total spin state of at least two electronic degrees of freedom.

20. The computer program product of claim 19, wherein the program instructions are executable by the processor to further cause the processor to:
generate, by the processor, a secondary result defining a time dependence of any selected spin-dependent quantity resulting from the defined Hamiltonian time evolution of the radical atomic pair.

21. The computer program product of claim 15, wherein the program instructions are executable by the processor to further cause the processor to:
reduce, by the processor, the number of qubits comprised by the set of qubits to be employed by generation of, by the processor, a plurality of partitions comprising respective Hamiltonian states with their corresponding degeneracies, wherein shot a set of shots executed at the quantum device to operate the quantum circuit comprises less than all Hamiltonian states of the quantum circuit.

22. A system, comprising:
a memory that stores computer executable components; and
a processor that executes the computer executable components stored in the memory, wherein the computer executable components comprise:
a quantum circuit generation component that instructs execution of a quantum gate of a quantum circuit by generating a quantum circuit based on a plurality of groups of magnetically equivalent nuclei of an atomic system and based on a set of parameters comprising an exact parameterization of a magnetic field strength acting on the atomic system, an exact parameterization of hyperfine coupling constants of the atomic system, and an exact parameterization of a pair of Landé g-factors of the atomic system,
wherein the exact parameterizations are expressed by a finite number of digits;
a quantum operation component that operates the quantum circuit on a set of qubits; and
an analysis component that, based on a measurement readout of a plurality of states of the set of qubits, generates a set of results defining a Hamiltonian time evolution of the radical atomic pairs.

23. The system of claim 22, wherein the quantum operation component operates the quantum circuit over a plurality of shots simulating a portion of the quantum circuit comprising a plurality of partitions that respectively comprise respective Hamiltonian states with their corresponding degeneracies.

24. A hybrid classical-quantum system, comprising:
a classical system comprising:
a memory that stores computer executable components, and
a processor that executes the computer executable components stored in the memory, wherein the computer executable components comprise
a quantum circuit generation component that instructs execution of a set of quantum gates of a quantum circuit by generating the quantum circuit based on a plurality of groups of magnetically equivalent nuclei of an atomic system,
wherein the atomic system comprises a plurality of radical atomic pairs having isotropic hyperfine couplings to three or more groups of magnetically equivalent nuclei of the plurality of groups of magnetically equivalent nuclei of the atomic system; and
a quantum system comprising
a quantum processor comprising a set of qubits, and
a quantum operation component that operates the quantum circuit on the set of qubits.

25. The hybrid classical-quantum system of claim 24, wherein the computer executable components further comprise:
an analysis component that, based on a measurement readout of a plurality of states of the set of qubits, generates a set of results defining a Hamiltonian time evolution of the plurality of radical atomic pairs.
